(19) United States
(12) Patent Application Publication
(10) Pub. No.: US 2012/0113060 A1
(43) Pub. Date: May 10, 2012

(54) SENSOR CIRCUIT AND DISPLAY APPARATUS

(75) Inventors: Hiromi Katoh, Osaka-shi (JP); Christopher Brown, Oxford (GB); Kohei Tanaka, Osaka-shi (JP)

(73) Assignee: SHARP KABUSHIKI KAISHA, Osaka-shi (JP)

(21) Appl. No.: 13/381,593

(22) PCT Filed: Jun. 23, 2010
(86) PCT No.: PCT/JP2010/060678

§ 371 Date: Dec. 29, 2011

(30) Foreign Application Priority Data
Jun. 30, 2009 (JP) 2009-155505

(51) Int. Cl. G06F 3/042; G01J 1/44

(52) U.S. Cl. 345/175; 250/214.1

(57) ABSTRACT

A sensor circuit or a display apparatus from which a highly accurate sensor output can be obtained includes a photodiode (photodetecting element); a capacitor connected to the photodiode via an accumulation node; a reset signal line to which a reset signal is supplied; a readout signal line to which a readout signal is supplied; a thin-film transistor (sensor switching element) that makes the accumulation node and an output line conductive with respect to each other and outputs an output signal according to the potential of the accumulation node; a microswitch that is capable of switching connection and disconnection between the accumulation node and an input electrode and provides connection when a pressure is applied by a touching operation; and a thin-film (control switching element) for switching conduction and non-conduction between the microswitch and the accumulation node.

### REFERENCE TO RELATED APPLICATIONS

This application is the national stage under 35 USC 371 of International Application No. PCT/JP2010/060678, filed Jun. 23, 2010, which claims the priority of Japanese Patent Application No. 2009-155505, filed Jun. 30, 2009, the entire contents of which are incorporated herein by reference.

### TECHNICAL FIELD

The present invention relates to a sensor circuit provided with an optical sensor having a photodetecting element and a touch sensor, and relates particularly to a sensor circuit and a display apparatus provided with an optical sensor and a touch sensor in a pixel region.

### BACKGROUND ART

Conventionally, an optical-sensor-equipped display apparatus has been proposed that is provided with photodetecting elements such as photodiodes in its pixels and thereby is capable of detecting a brightness of external light and capturing an image of an object approaching its display panel. Such an optical-sensor-equipped display apparatus is supposed to be used as a display apparatus for two-way communication, or a display apparatus having a touch panel function.

In the case of a conventional optical-sensor-equipped display apparatus, when known composing elements such as signal lines, scanning lines, TFTs (thin film transistors), and pixel electrodes are formed on a base substrate of an active matrix substrate through semiconductor processing, photodiodes and the like are formed thereon through the same processing (see, for example, JP 2006-3857 A, and “A Touch Panel Function Integrated LCD Including LTPS A/D Converter”, T. Nakamura et al., SID 05 DIGEST, pp. 1054-1055, 2005).

Further, a display apparatus obtained by modifying the above-described optical-sensor-equipped display apparatus by adding a touch sensor so as to obtain outputs of two sensor systems has been known (see, for example, JP 2006-133788 A, and “FDP International 2008 Forum A-32”, Latest Trends of Touch Panel Development, Korea, Samsung Electronics Co., Ltd., Nam Deog Kim et al., 2008). In use of such a display apparatus in which sensor outputs from both of the optical sensor and the touch sensor can be obtained, an improvement can be expected in the sensor sensitivity and the sensor accuracy with respect to a touching operation.

### SUMMARY OF THE INVENTION

An optical sensor system utilizing photodiodes or the like can be used, not only as a function of a touch panel, but also as a function of a scanner or the like, in an optical-sensor-equipped display apparatus. The optical sensor system, however, tends to be influenced by external light easily, and therefore the performance thereof as a touch panel tends to depend on a state of the external light. Thus, the optical sensor system is not suitable for mobile equipment that is expected to be used under various environments.

Then, a configuration in which microswitches are provided in a panel can be considered possible as a configuration that allows the function as a touch panel to be exhibited under any environment. For example, by adding a function of a microswitch to an optical sensor circuit, an advantage that a function as a touch panel can be added to a device using optical sensors, and an advantage that the touch panel function can be achieved under any environment are achieved, whereby an ideal sensor function can be realized.

FIG. 19 shows an equivalent circuit in the case where a touch sensor having a microswitch S1 and an optical sensor having a photodiode D1 are combined. Here, a thin-film transistor M1 functions as a passive switch. In the configuration shown in FIG. 19, a high S/N ratio and a high-speed readout can be realized by using a special driver IC that reads out a slight electric current, etc. The use of such a special driver IC or the like, however, makes the circuit configuration complicated.

On the other hand, FIG. 20 shows an exemplary configuration in which the thin-film transistor M1 is provided as a source follower to realize an active system. In FIG. 20, when the microswitch S1 is turned on by a touching operation after a reset signal is supplied to a line RST, even if a voltage of a line RWS is shifted from a high level to a low level so as to shift the thin-film transistor M2 from an ON state to an OFF state, charges of a junction node V_{INT} do not go to any node. Therefore, the junction node V_{INT} assumes a floating state.

FIG. 21 shows variation of a potential of the junction node V_{INT} in a process from the supply of the reset signal to readout. In the case where the junction node V_{INT} is in a floating state, the thin-film transistor M1 is kept in an ON state after a readout period as shown in FIG. 21, and consequently, an accurate sensor output cannot be obtained.

It is an object of the present invention to realize a configuration that makes it possible to obtain a highly accurate sensor output, in a sensor circuit and a display apparatus having an optical sensor and a touch sensor.

A sensor circuit or a display apparatus according to one embodiment of the present invention includes: a photodetecting element that receives incident light; an accumulation part that is connected to the photodetecting element via an accumulation node and accumulates charges according to an electric current having flown through the photodetecting element; a reset signal line for supplying, to the accumulation node, a reset signal including reset voltage application for initializing a potential of the accumulation node; a readout signal line for supplying, to the accumulation node, a readout signal including readout voltage application for outputting the potential of the accumulation node; a sensor switching element that is connected to an output line, so as to make the accumulation node and the output line conductive with each other in response to the readout voltage application, and to output an output signal according to the potential of the accumulation node to the output line; a switch that is capable of switching connection and disconnection between the accumulation node and an input electrode to which a voltage is supplied, and that provides connection when a pressure is applied by a touching operation; and a control switching element that is connected to between the switch and the accumulation node, and has a control electrode to which a control signal for switching conduction and non-conduction between the switch and the accumulation node is input.

The present embodiment makes it possible to provide a sensor circuit and a display apparatus in which a highly accurate sensor output can be obtained from an optical sensor and a touch sensor.

### BRIEF DESCRIPTION OF DRAWINGS

FIG. 1 is a block diagram showing a schematic configuration of a display apparatus according to one embodiment of the present invention.

FIG. 2 is an equivalent circuit diagram showing a configuration of one pixel in a display apparatus according to one embodiment of the present invention.

(a) of FIG. 3A is a waveform diagram showing input signals supplied from a line MODE, a line RWS, and a line RST in a sensor circuit according to one embodiment of the present invention, and (b) of FIG. 3A shows potential variation of V_{INT} with respect to the input signals.

(a) of FIG. 3B is a waveform diagram showing input signals supplied from a line MODE, a line RWS, and a line RST in a sensor circuit according to one embodiment of the present invention, and (b) of FIG. 3B shows potential variation of V_{INT} with respect to the input signals.

(a) of FIG. 3C is a waveform diagram showing input signals supplied from a line MODE, a line RWS, and a line RST in a sensor circuit according to one embodiment of the present invention, and (b) of FIG. 3C shows potential variation of V_{INT} with respect to the input signals.

FIG. 4A is a plan view showing an exemplary planar structure of a sensor circuit according to one embodiment of the present invention.

FIG. 4B is a cross-sectional view showing an exemplary microswitch S1 according to one embodiment of the present invention.

FIG. 4C is a cross-sectional view showing an exemplary microswitch S1 according to one embodiment of the present invention.

FIG. 5 is an equivalent circuit diagram of a sensor circuit according to one embodiment of the present invention.

FIG. 6 shows potential variation of V_{INT} in a sensor circuit according to one embodiment of the present invention.

FIG. 7 is an equivalent circuit diagram of a sensor circuit according to one embodiment of the present invention.

(a) of FIG. 8A is a waveform diagram showing input signals supplied from a line MODE, a line RWS, and a line RST in a sensor circuit according to one embodiment of the present invention, and (b) of FIG. 8A shows potential variation of V_{INT} with respect to the input signals.

(a) of FIG. 8B is a waveform diagram showing input signals supplied from a line MODE, a line RWS, and a line RST in a sensor circuit according to one embodiment of the present invention, and (b) of FIG. 8B shows potential variation of V_{INT} with respect to the input signals.

(a) of FIG. 8C is a waveform diagram showing input signals supplied from a line MODE, a line RWS, and a line RST in a sensor circuit according to one embodiment of the present invention, and (b) of FIG. 8C shows potential variation of V_{INT} with respect to the input signals.

FIG. 9 is an equivalent circuit diagram of a sensor circuit according to one embodiment of the present invention.

(a) of FIG. 10A is a waveform diagram showing input signals supplied from a line MODE, a line RWS, and a line RST in a sensor circuit according to one embodiment of the present invention, and (b) of FIG. 10A shows potential variation of V_{INT} with respect to the input signals.

(a) of FIG. 10B is a waveform diagram showing input signals supplied from a line MODE, a line RWS, and a line RST in a sensor circuit according to one embodiment of the present invention, and (b) of FIG. 10B shows potential variation of V_{INT} with respect to the input signals.

(a) of FIG. 10C is a waveform diagram showing input signals supplied from a line MODE, a line RWS, and a line RST in a sensor circuit according to one embodiment of the present invention, and (b) of FIG. 10C shows potential variation of V_{INT} with respect to the input signals.

FIG. 11 is an equivalent circuit diagram of a sensor circuit according to one embodiment of the present invention.

(a) of FIG. 12A is a waveform diagram showing input signals supplied from a line RWS, and a line RST in a sensor circuit according to one embodiment of the present invention, and (b) of FIG. 12A shows potential variation of V_{INT} with respect to the input signals.

(a) of FIG. 12B is a waveform diagram showing input signals supplied from a line RWS, and a line RST in a sensor circuit according to one embodiment of the present invention, and (b) of FIG. 12B shows potential variation of V_{INT} with respect to the input signals.

(a) of FIG. 12C is a waveform diagram showing input signals supplied from a line RWS, and a line RST in a sensor circuit according to one embodiment of the present invention, and (b) of FIG. 12C shows potential variation of V_{INT} with respect to the input signals.

FIG. 13 is an equivalent circuit diagram of a sensor circuit according to one embodiment of the present invention.

FIG. 14 shows potential variation of V_{IN} in a sensor circuit according to one embodiment of the present invention.

FIG. 15 is an equivalent circuit diagram of a sensor circuit according to one embodiment of the present invention.

(a) of FIG. 16A is a waveform diagram showing input signals supplied from a line RWS and a line RST in a sensor circuit according to one embodiment of the present invention, and (b) of FIG. 16A shows potential variation of V_{INT} with respect to input signals.

(a) of FIG. 16B is a waveform diagram showing input signals supplied from a line RWS and a line RST in a sensor circuit according to one embodiment of the present invention, and (b) of FIG. 16B shows potential variation of V_{INT} with respect to input signals.

(a) of FIG. 16C is a waveform diagram showing input signals supplied from a line RWS and a line RST in a sensor circuit according to one embodiment of the present invention, and (b) of FIG. 16C shows potential variation of V_{INT} with respect to input signals.

FIG. 17 is an equivalent circuit diagram of a sensor circuit according to one embodiment of the present invention.

(a) of FIG. 18A is a waveform diagram showing input signals supplied from a line RWS and a line RST in a sensor circuit according to one embodiment of the present invention, and (b) of FIG. 18A shows potential variation of V_{INT} with respect to input signals.

(a) of FIG. 18B is a waveform diagram showing input signals supplied from a line RWS and a line RST in a sensor circuit according to one embodiment of the present invention, and (b) of FIG. 18B shows potential variation of V_{INT} with respect to input signals.

(a) of FIG. 18C is a waveform diagram showing input signals supplied from a line RWS and a line RST in a sensor circuit according to one embodiment of the present invention, and (b) of FIG. 18C shows potential variation of V_{INT} with respect to input signals.

FIG. 19 is an equivalent circuit diagram of a sensor circuit for consideration of the problems to be solved by the present invention.

FIG. 20 is an equivalent circuit diagram of a sensor circuit for consideration of the problems to be solved by the present invention.

FIG. 21 shows potential variation of V_{INT} in a sensor circuit for consideration of the problems to be solved by the present invention.

### DETAILED DESCRIPTION OF THE INVENTION

(1) A sensor circuit according to one embodiment of the present invention includes: a photodetecting element that receives incident light; an accumulation part that is connected to the photodetecting element via an accumulation node and accumulates charges according to an electric current having flown through the photodetecting element; a reset signal line to which a reset signal for initializing a potential of the accumulation node is supplied; a readout signal line to which a readout signal for outputting the potential of the accumulation node is supplied; a sensor switching element that is connected to an output line, so as to make the accumulation node and the output line conductive with each other in response to input of the readout signal, and to output an output signal according to the potential of the accumulation node to the output line; a switch that is capable of switching connection and disconnection between the accumulation node and an input electrode to which a voltage is supplied, and that provides connection when a pressure is applied by a touching operation; and a control switching element that is connected to between the switch and the accumulation node, and has a control electrode to which a control signal for switching conduction and non-conduction between the switch and the accumulation node is input (first configuration).

In this configuration, charges are accumulated in the accumulation node according to an electric current having flown through the photodetecting element. Therefore, the potential of the accumulation node after the initialization by input of the reset signal varies with the electric current having flown through the photodetecting element. The potential of the accumulation node is read out by the sensor switching element when the readout signal is input. Therefore, an output signal according to the potential of the accumulation node is output from the sensor switching element.

Here, since the accumulation node is connected to the switch via the control switching element, the influence given by the connection state of the switch upon readout onto the potential of the accumulation node can be controlled by the control switching element. This makes it possible to control the detection regarding whether both of the connection state of the switch and the electric current flowing through the photodetecting element are to be detected, or either one of these is to be detected. For example, when the switch is in the connection state, the accumulation node is connected to the input electrode, and by making the control switching element conductive upon the readout voltage application, charges in the accumulation part can be transferred to the input electrode. By doing so, a touching operation can be detected according to the potential of the accumulation node upon readout. Moreover, since the potential of the accumulation node transfers, a floating state of the potential of the accumulation node that would cause the sensor output to be kept in an ON state can be avoided, whereby an accurate sensor output can be obtained. Further, when there is no touching operation and the switch is in a disconnection state, a potential of the accumulation node according to an amount of an electric current of the photodetecting element is output.

(2) In the above-described first configuration, the control electrode of the control switching element may be connected to a control line that supplies the control signal (second configuration). This configuration makes it possible to control conduction and non-conduction of the control switching element at an arbitrary timing by using the control line.

(3) In the above-described second configuration, the input electrode may be connected to a reference voltage line to which a voltage is supplied (third configuration). This configuration makes it possible to discharge charges of the accumulation part by using the reference voltage line connected to the sensor circuit. For example, in the case where the aforementioned configuration is applied to a liquid crystal display device, the input electrode may be connected to a counter electrode provided on a counter substrate, a reference power supply voltage provided on an active matrix substrate, etc.

(4) In the second configuration, the input electrode may be connected to the reset signal line (fourth configuration). This configuration makes it possible to discharge charges of the accumulation part by using the reset signal line indispensable for the sensor circuit. Therefore, the number of lines in the sensor circuit can be reduced, whereby an aperture ratio can be increased.

(5) In the second configuration, the input electrode may be connected to the readout signal line (fifth configuration). This configuration makes it possible to discharge charges of the accumulation part by using the readout signal line indispensable for the sensor circuit. Therefore, the number of lines in the sensor circuit can be reduced, whereby an aperture ratio can be increased.

(6) In any one of the above-described first through fifth configuration, the sensor circuit preferably operates in operation modes that include: an operation mode in which the control switching element is caused to operate according to the control signal when the readout signal is input so that the switch and the accumulation node become conductive with each other; and an operation mode in which the control switching element is caused to operate according to the control signal so that the switch and the accumulation node are always non-conductive with each other (sixth configuration).

This configuration makes it possible to arbitrarily select an operation mode in which the control switching element operates, and therefore to obtain a sensor output according to the operation mode. For example, it is possible to select an operation mode in which the switch and the accumulation node are made conductive with each other so that the presence/absence of a touching operation can be detected, and an operation mode in which the switch and the accumulation node are made non-conductive with each other so that an amount of an electric current of the photodetecting element can be determined. In each operation mode, highly accurate sensing can be performed based on the potential of the accumulation node.

(7) In the first configuration, the control electrode of the control switching element may be connected to the readout signal line (seventh configuration). This configuration makes it possible to control the control switching element by using the readout signal line indispensable for the sensor circuit. Therefore, since a line for connection to the control electrode of the control switching element is unnecessary, the number of lines in the sensor circuit can be reduced, whereby the aperture ratio can be increased.

(8) In the seventh configuration, the input electrode may be also connected to the readout signal line (eighth configuration). In this configuration, not only the control electrode of the control switching element but also the switch is connected to the readout signal line, and therefore, the operation of the switch is made effective exclusively during the readout period. Consequently, a touching operation can be made effective exclusively during the readout period.

(9) In the seventh or eighth configuration, the sensor circuit preferably operates in operation modes that include: an operation mode in which a readout signal for making the control switching element conductive when the readout signal is input is supplied to the readout signal line; and an operation mode in which a readout signal for making the control switching element non-conductive when the readout signal is input is supplied to the readout signal line (ninth configuration).

This configuration makes it possible to arbitrarily select an operation mode in which the control switching element operates, and therefore to obtain a sensor output according to the operation mode. For example, it is possible to select an operation mode in which the control switching element is made conductive so that the presence/absence of a touching operation can be detected, and an operation mode in which the control switching element is made non-conductive so that an amount of an electric current of the photodetecting element can be determined. In each operation mode, highly accurate sensing can be performed based on the potential of the accumulation node.

(10) In the above-described first configuration, it is preferable that the control electrode of the control switching element is connected to the reset signal line, and the input electrode is connected to the readout signal line (tenth configuration).

This configuration makes it possible to control the control switching element by using the reset signal line indispensable for the sensor circuit. Therefore, the number of lines in the sensor circuit can be reduced, whereby the aperture ratio can be increased. Besides, since the switch is connected to the readout signal line, the operation of the switch is made effective exclusively during the readout period. Consequently, a touching operation can be made effective exclusively during the readout period.

(11) In the tenth configuration, the sensor circuit preferably operates in operation modes that include: an operation mode in which a voltage of the readout signal is set so that the control switching element becomes conductive when the reset signal is input; and an operation mode in which a voltage of the readout signal is set so that the control switching element becomes non-conductive when the reset signal is input (eleventh configuration).

This configuration makes it possible to arbitrarily select an operation mode in which the control switching element operates, and therefore to obtain a sensor output according to the operation mode. For example, it is possible to select an operation mode in which the control switching element is made conductive so that the presence/absence of a touching operation can be detected, and an operation mode in which the control switching element is made non-conductive so that an amount of an electric current of the photodetecting element can be determined. In each operation mode, highly accurate sensing can be performed based on the potential of the accumulation node.

(12) The sensor circuit of each above-described sensor circuit can be applied to a display apparatus that includes an optical sensor in a pixel region of an active matrix substrate (twelfth configuration).

(13) In the twelfth configuration, the switch preferably includes: a first electrode that is provided on the active matrix substrate and is connected to the accumulation node; and a second electrode that is provided on a counter substrate and is connected to the input electrode, wherein the first electrode and the second electrode are brought into contact with each other when the counter substrate is pressed by a touching operation with respect to the pixel region (thirteenth configuration).

(14) In the twelfth configuration, the switch preferably includes: a first electrode that is provided on the active matrix substrate and is connected to the accumulation node; and a second electrode that is provided on the active matrix substrate at a distance from the first electrode, and is connected to the input electrode, wherein the first electrode and the second electrode are brought into contact with a conductor provided on a counter substrate and become conductive with each other when the counter substrate is pressed by a touching operation with respect to the pixel region (fourteenth configuration).

(15) A sensor circuit according to one embodiment of the present invention includes: a photodetecting element that receives incident light; an accumulation part that accumulates a potential according to an output electric current of the photodetecting element, in an accumulation node; a reset signal line to which a reset signal for initializing a potential of the accumulation node is supplied; a readout signal line to which a readout signal for reading out the potential of the accumulation node is supplied; an amplification part that reads out the potential of the accumulation node in response to the readout signal and outputs an output signal according to the potential; a switch for switching connection and disconnection from one to the other in response to a pressure applied by a touching operation; and a control switching element that controls conduction and non-conduction between the switch and the accumulation node, wherein the sensor circuit operates in at least two operation modes among an imager mode, a touch mode, and a hybrid mode, wherein in the imager mode, the control switching element is controlled so that the potential of the accumulation node depends on an electric current that has flown through the photodetecting element during a period from the initialization by the reset signal to the readout by the readout signal; in the touch mode, the control switching element is controlled so that the potential of the accumulation node depends on a connection state of the switch upon the readout by the readout signal; and in the hybrid mode, the control switching element is controlled so that the potential of the accumulation node depends on both of the electric current having flown through the photodetecting element and the connection state of the switch (fifteenth configuration).

In this configuration, since charges are accumulated in the accumulation node according to an electric current having flown through the photodetecting element, the potential of the accumulation node after the initialization by input of the reset signal varies with the electric current having flown through the photodetecting element. The potential of the accumulation node is read out by the amplification part upon the readout voltage application. As a result, an output signal according to the potential of the accumulation node is output from the amplification part.

Here, since the accumulation node is connected to the switch via the control switching element, the influence given by the connection state of the switch upon readout onto the potential of the accumulation node can be controlled by the control switching element. This makes it possible to control the detection regarding whether both of the connection state of the switch and the electric current flowing through the photodetecting element are to be detected, or either one of these is to be detected. Besides, this configuration makes it possible to arbitrarily select an operation mode in which the control switching element operates, and therefore to obtain a sensor output according to the operation mode. Consequently, in each operation mode, highly accurate sensing can be performed based on the potential of the accumulation node.

(16) In the fifteenth configuration, it is preferable that in the imager mode, a voltage of the reset signal is set so that charges according to an electric current having flown through the photodetecting element are accumulated in the accumulation part during a period from the initialization of the accumulation node by the reset signal to the readout by the readout signal; and the control switching element is controlled so that it is non-conductive at least upon the readout (sixteenth configuration).

(17) In the fifteenth configuration, it is preferable that, in the touch mode, the voltage of the reset signal is set so that the accumulation node is initialized upon the readout, and the control switching element is controlled so that it is conductive upon the readout (seventeenth configuration).

(18) In the fifteenth configuration, it is preferable that, in the hybrid mode, the control switching element is controlled so that it is conductive upon readout; a voltage of the reset signal is set so that charges according to an electric current having flown through the photodetecting element are accumulated in the accumulation part during a period from the initialization of the accumulation node by the reset signal to the readout by the readout signal; and when the switch is conductive upon readout, a voltage is applied to the switch (eighteenth configuration).

Hereinafter, more specific embodiments of the present invention are explained with reference to the drawings. It should be noted that the following embodiments show exemplary configurations in the case where a display apparatus is embodied as a liquid crystal display device, but the display apparatus is not limited to a liquid crystal display device, and the present invention is applicable to an arbitrary display apparatus in which an active matrix substrate is used. It should be noted that a display apparatus, as having optical sensors, is assumed to be used as a touch-panel-equipped display device that detects an object approaching its screen and carries out an input operation, as a display apparatus for two-way communication having a display function and an image pickup function, etc.

Further, the drawings referred to hereinafter show, in a simplified manner, only principal members needed for explanation of the present invention among composing members of the embodiment of the present invention, for convenience of explanation. Therefore, a display apparatus according to the present embodiment may include arbitrary members that are not shown in the drawings that the present specification refers to. Further, the dimensions of the members shown in the drawings do not faithfully reflect actual dimensions of composing members, dimensional ratios of the members, etc.

### 1. First Embodiment

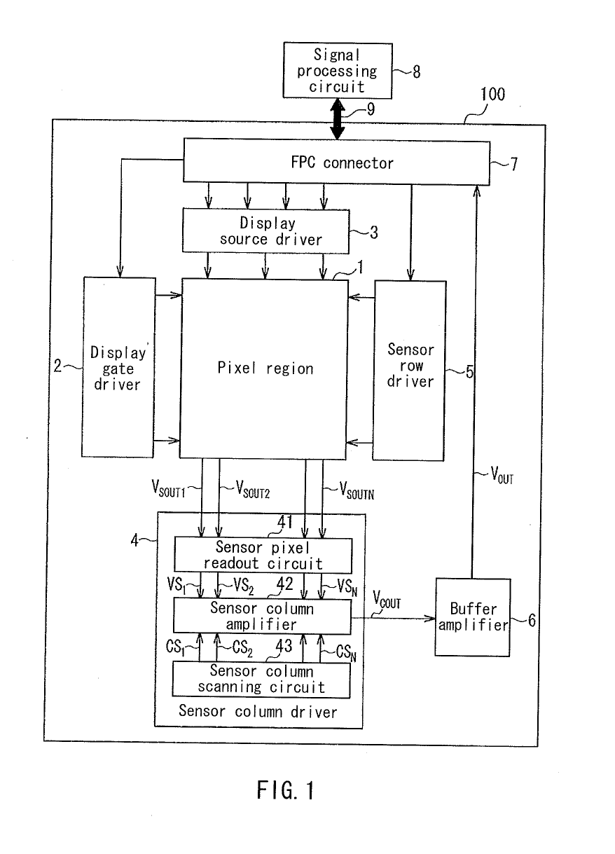

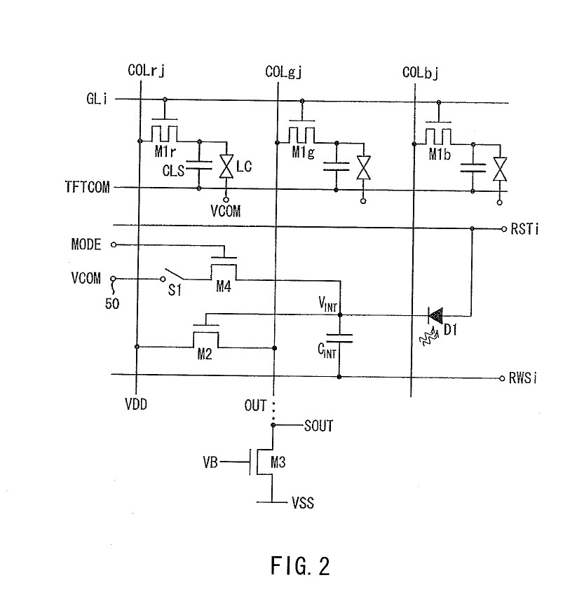

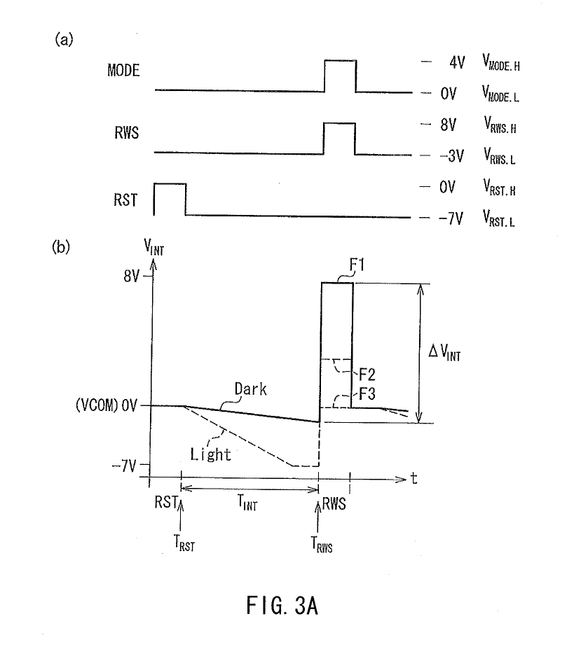

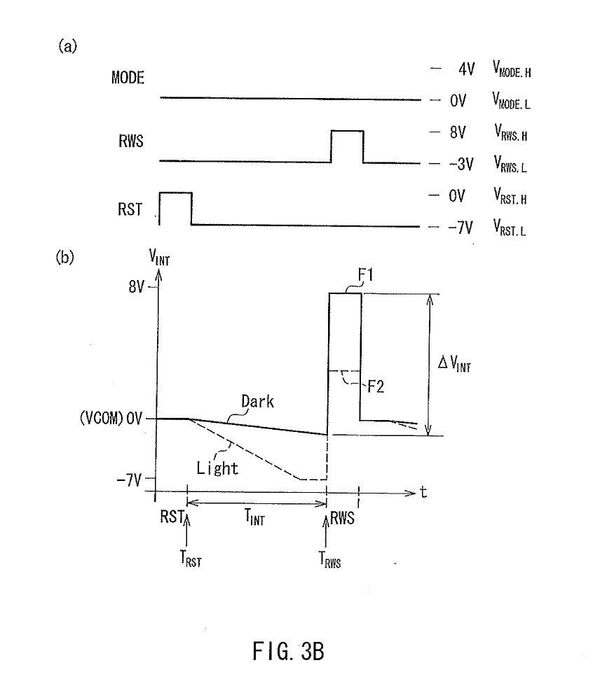

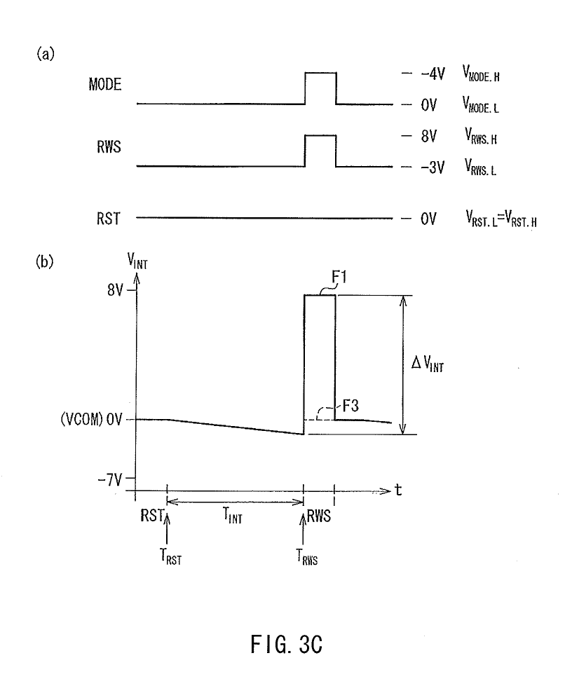

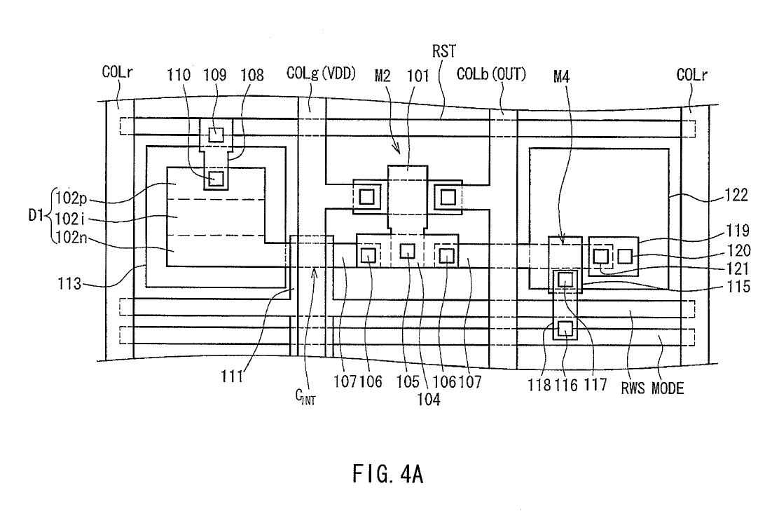

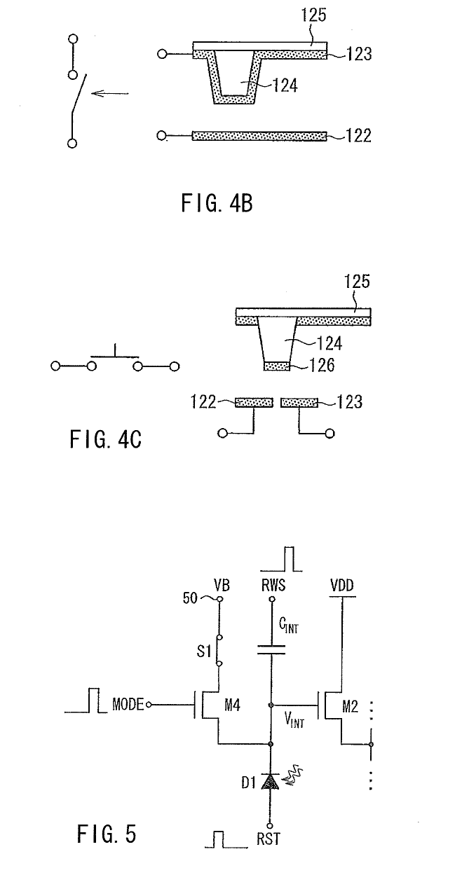

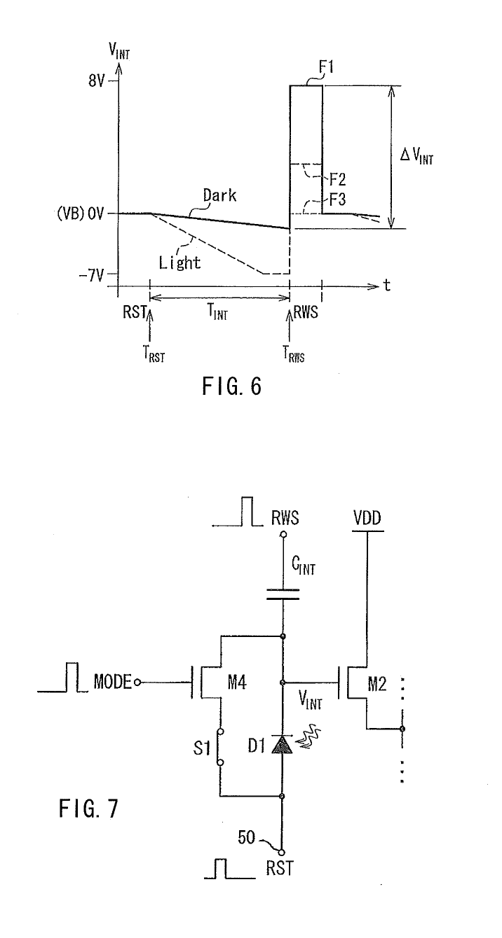

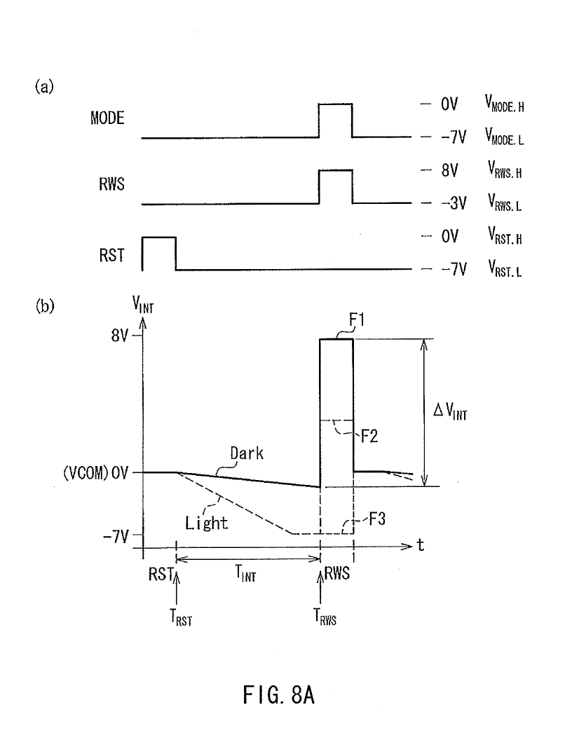

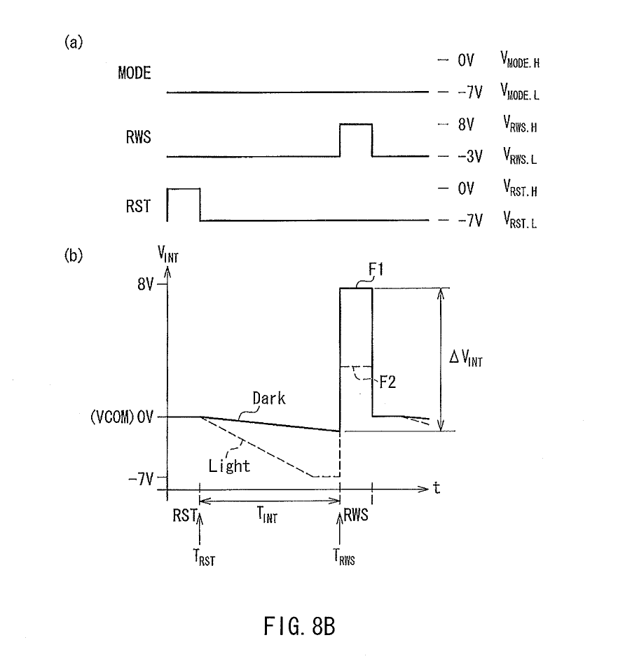

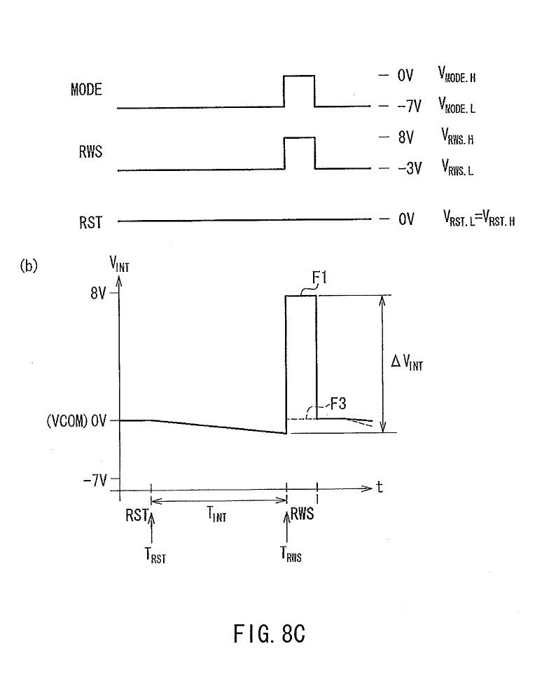

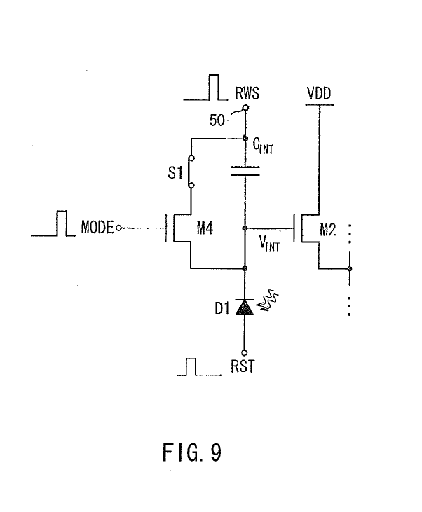

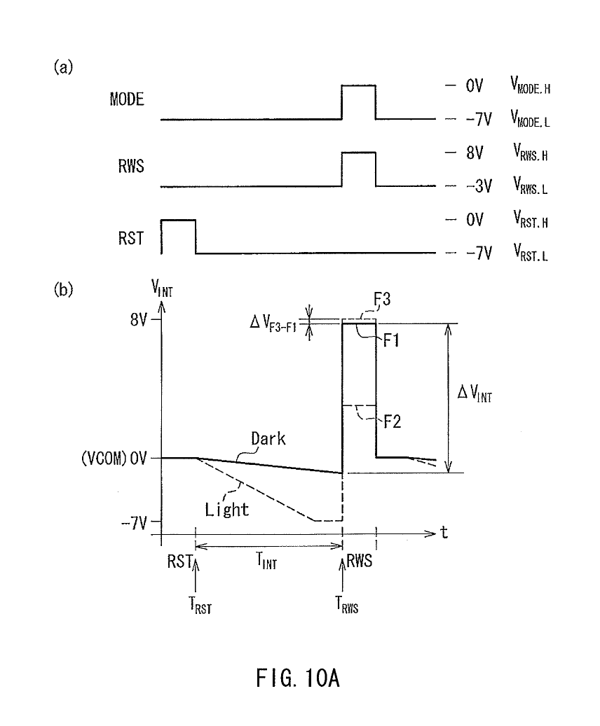

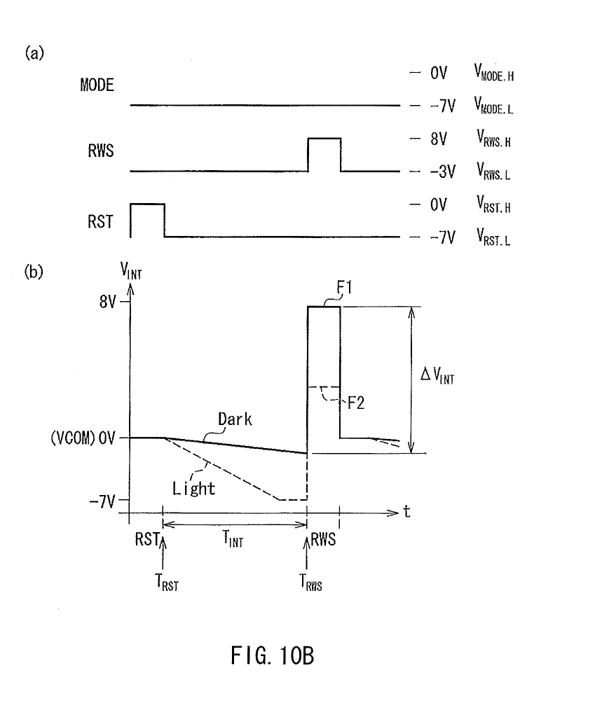

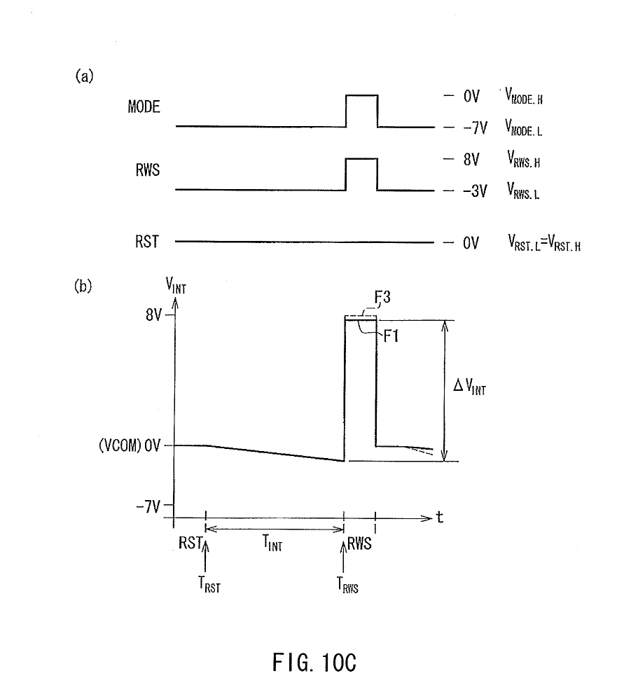

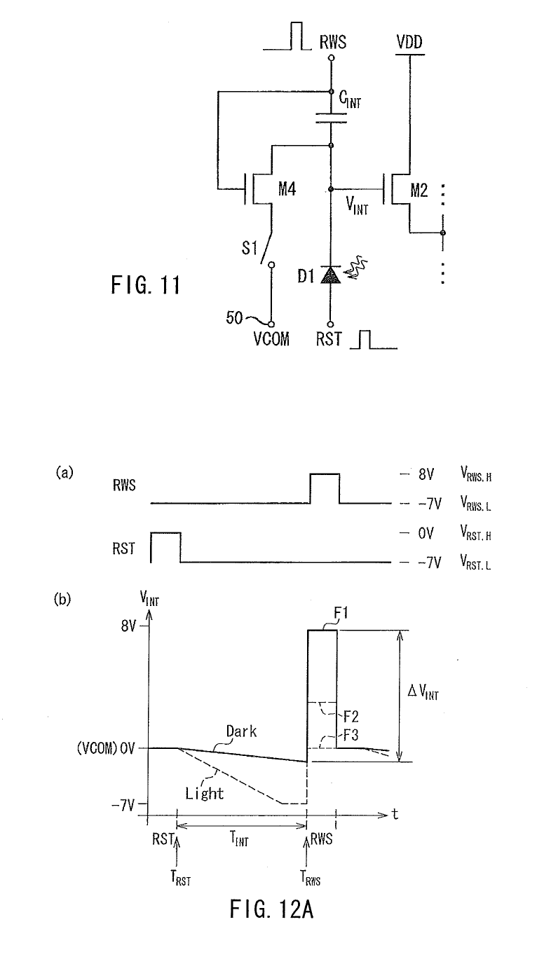

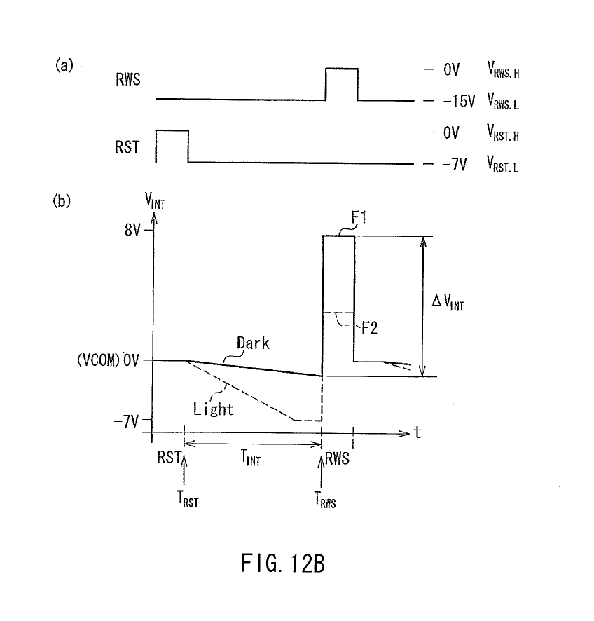

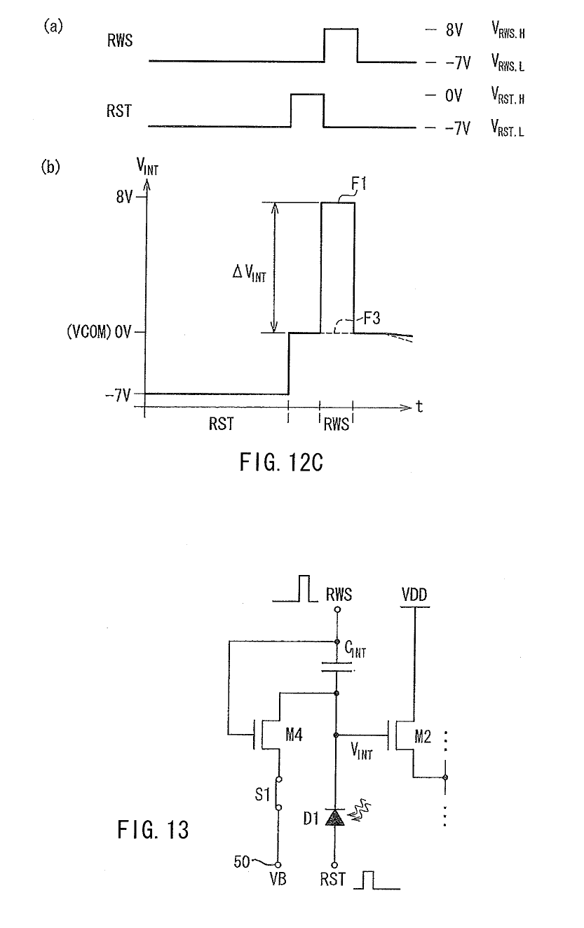

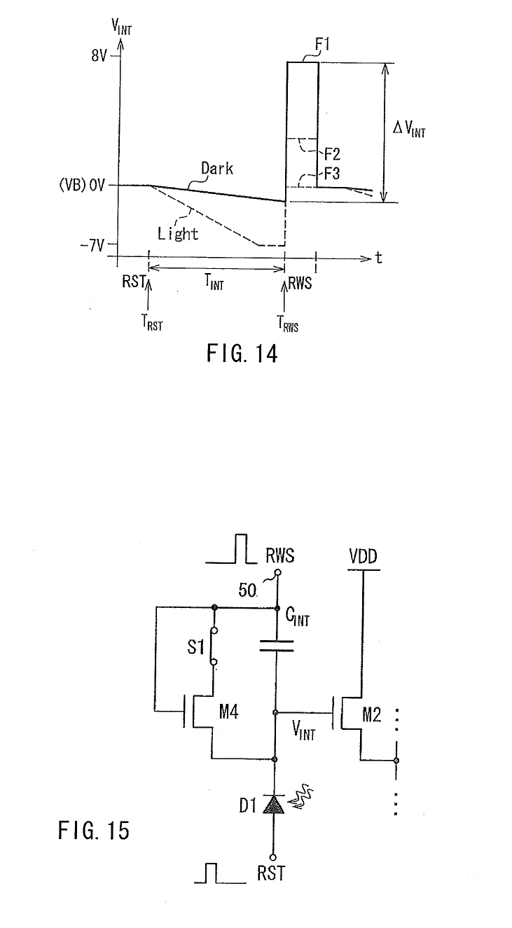

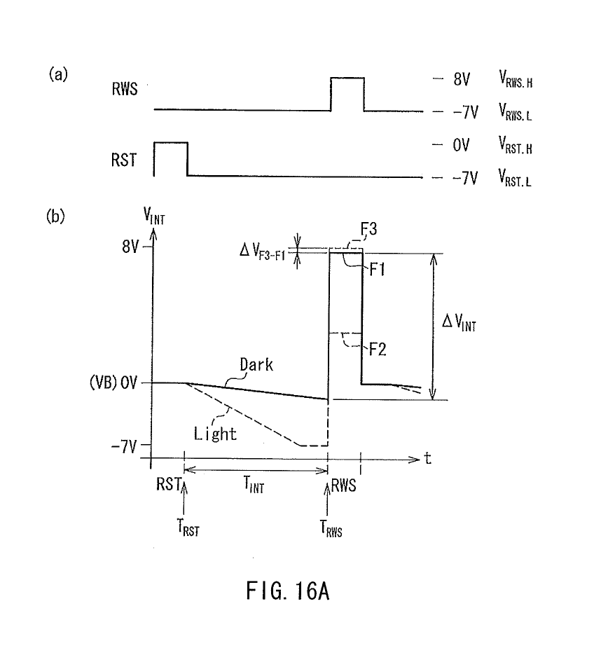

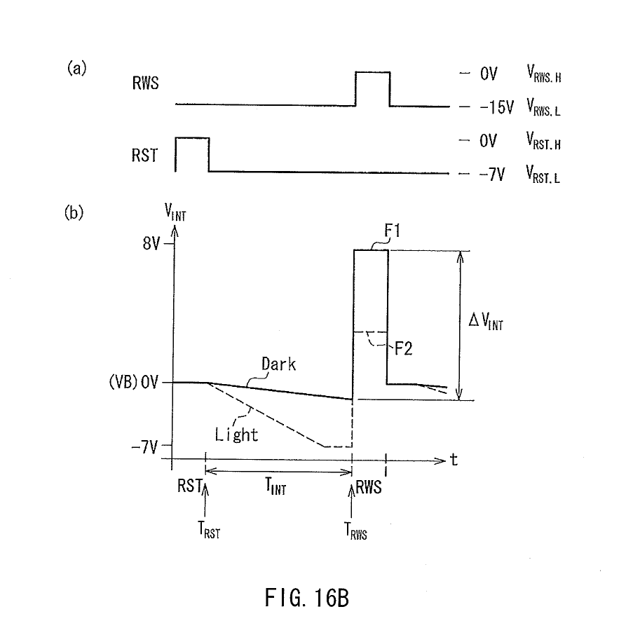

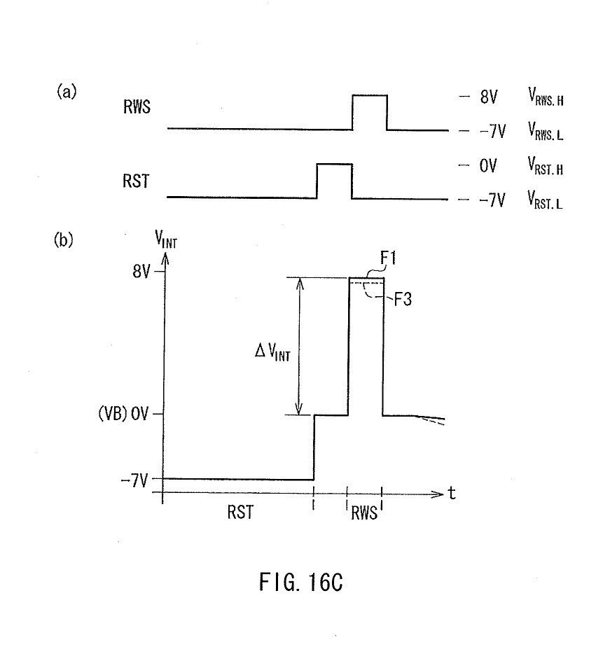

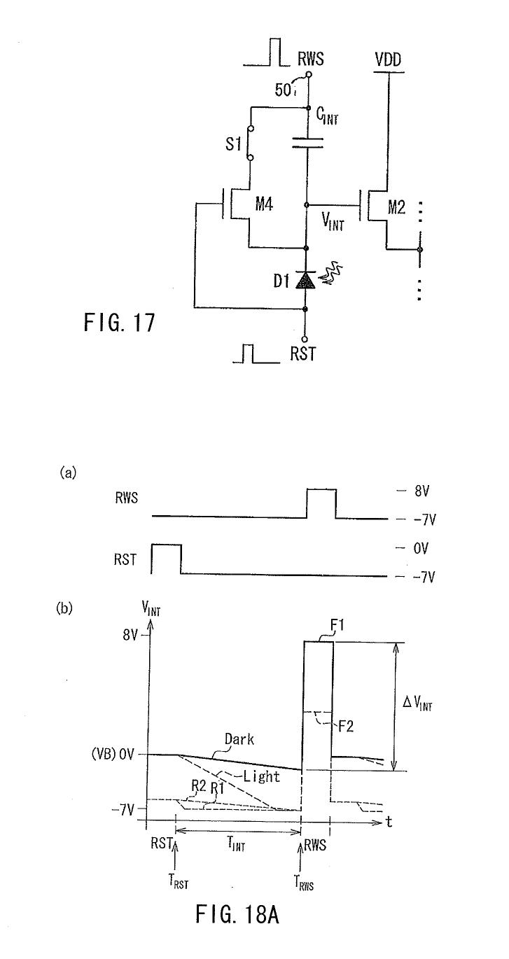

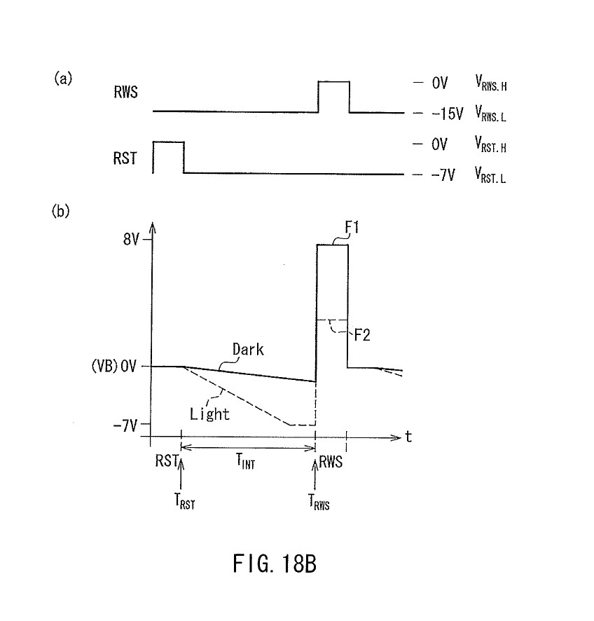

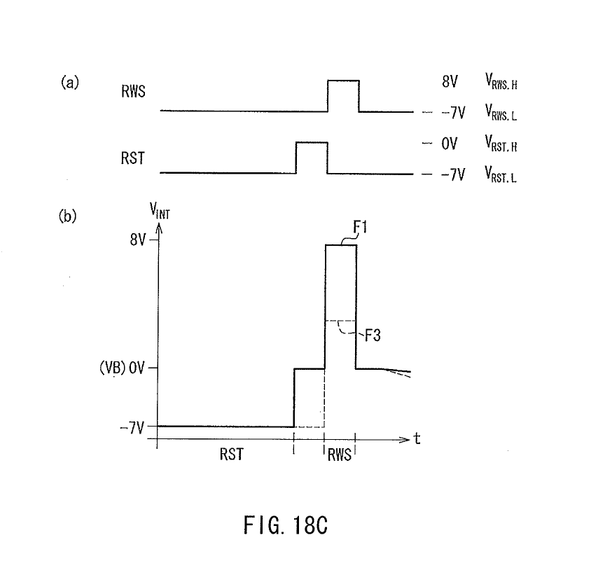

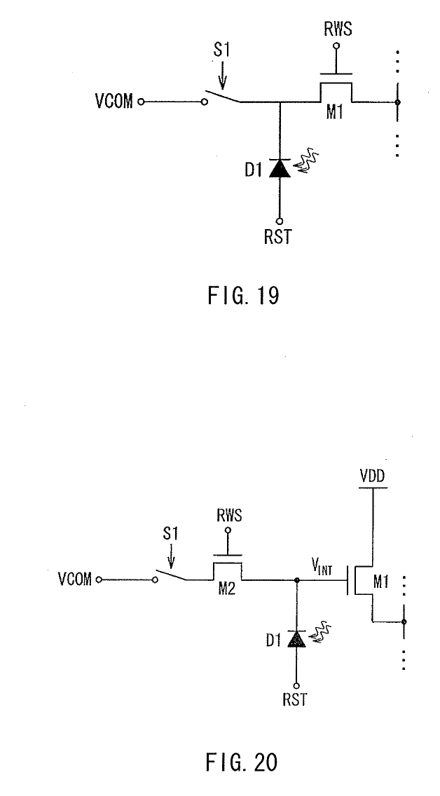

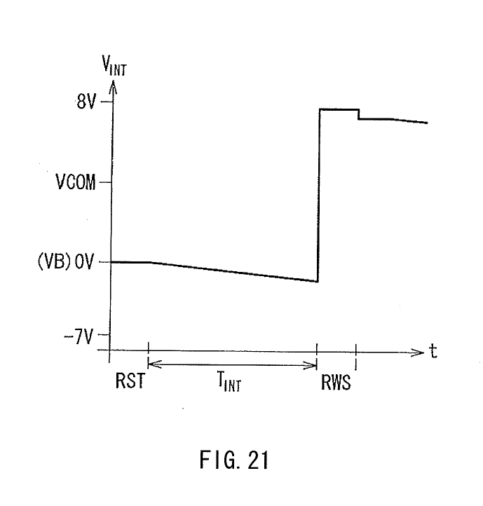

First, a configuration of an active matrix substrate provided in a liquid crystal display device according to First Embodiment is explained with reference to FIGS. 1 and 2.

FIG. 1 is a block diagram illustrating a schematic configuration of an active matrix substrate 100 provided in a liquid crystal display device according to one embodiment of the present invention. As shown in FIG. 1, the active matrix substrate 100 includes, on its glass substrate, at least a pixel region 1, a display gate driver 2, a display source driver 3, a sensor column driver 4, a sensor row driver 5, a buffer amplifier 6, and an FPC (flexible printed circuit) connector 7. Further, a signal processing circuit 8 for processing an image signal captured by a photodetecting element (to be described later) and/or a switch (to be described later) in the pixel region 1 is connected to the active matrix substrate 100 via the FPC connector 7 and an FPC 9.

The sensor column driver 4 includes a sensor pixel readout circuit 41, a sensor column amplifier 42, and a sensor column scanning circuit 43. To the sensor pixel readout circuit 41, an output line SOUT (see FIG. 2) for outputting a sensor output V_{SOUT} from the pixel region 1 is connected. In FIG. 1, sensor outputs from output lines SOUTj (j=1 to N) are denoted by V_{SOUT1} to V_{SOUTN}, respectively. The sensor pixel readout circuit 41 outputs a peak hold voltage VSⱼ (j=1 to N) of the sensor output V_{SOUTj} (j=1 to N) to the sensor column amplifier 42.

The sensor column amplifier 42 incorporates N column amplifiers that correspond to N columns of optical sensors in the pixel region 1, respectively. The sensor column amplifier 42 amplifies the peak hold voltage VSⱼ (j=1 to N) by each column amplifier, thereby outputting it as V_{COUT} to the buffer amplifier 6. The sensor column scanning circuit 43 outputs a column select signal CSj (j=1 to N) to the sensor column amplifier 42 in order to connect the column amplifiers of the sensor column amplifier 42 sequentially to the output of the buffer amplifier 6. The buffer amplifier 6 further amplifies V_{COUT} output from the sensor column amplifier 42, and outputs the same as a panel output V_{OUT} to the signal processing circuit 8 via the FPC connector 7.

It should be noted that the above-described members on the active matrix substrate 100 may be formed monolithically on the glass substrate through semiconductor processing. Alternatively, the configuration may be as follows: the amplifiers and drivers among the above-described members may be mounted on the glass substrate by, for example, COG (chip on glass) techniques. Further alternatively, at least a part of the aforementioned members shown on the active matrix substrate 100 in FIG. 1 could be mounted on the FPC 9. The active matrix substrate 100 is laminated with a counter substrate (not shown) having a counter electrode formed over an entire surface thereof. A liquid crystal material is sealed in the space between the active matrix substrate 100 and the counter substrate.

The pixel region 1 is a region where a plurality of pixels are formed for displaying images. In the present embodiment, an optical sensor for capturing images is provided in each pixel in the pixel region 1. FIG. 2 is an equivalent circuit diagram showing an arrangement of pixels and sensor circuits (optical sensors and touch sensors) in the pixel region 1 in the active matrix substrate 100. In the example shown in FIG. 2, one pixel is formed with three primary color dots of R (red), G (green), and B (blue). In one pixel composed of these three color dots, there is provided one sensor circuit composed of a photodiode D1, a capacitor C_{INT} (accumulation part), a thin-film transistor M2, a thin-film transistor M4, and a microswitch S1. The pixel region 1 includes the pixels arrayed in a matrix of M rows×N columns, and the sensor circuits arrayed likewise in a matrix of M rows×N columns. It should be noted that the number of the color dots is M×3N, since one pixel is composed of three dots, as described above.

As shown in FIG. 2, the pixel region 1 has gate lines GL and source lines COL arrayed in matrix as lines for pixels. The gate lines GL are connected with the display gate driver 2. The source lines COL are connected with the display source driver 3. It should be noted that M rows of the gate lines GL are provided in the pixel region 1. Hereinafter, when an individual gate line GL needs to be described distinctly, it is denoted by GLi (i=1 to M). On the other hand, three source lines COL are provided per one pixel so as to supply image data to three color dots in the pixel, as described above. When an individual source line COL needs to be described distinctly, it is denoted by COLrj, COLgj, or COLbj (j=1 to N).

At each of intersections of the gate lines GL and the source lines COL, a thin-film transistor (TFT) M1 is provided as a switching element for a pixel. It should be noted that in FIG. 2, the thin film transistors M1 provided for color dots of red, green, and blue are denoted by M1r, M1g, and M1b, respectively. A gate electrode of the thin-film transistor M1 is connected to the gate line GL, a source electrode thereof is connected to the source line COL, and a drain electrode thereof is connected to a pixel electrode, which is not shown. Thus, a liquid crystal capacitor LC is formed between the drain electrode of the thin film transistor M1 and the counter electrode (VCOM), as shown in FIG. 2. Further, an auxiliary capacitor CLS is formed between the drain electrode and a TFT COM.

In FIG. 2, for a color dot driven by a thin-film transistor M1r connected to an intersection of one gate line GLi and one source line COLrj, a red color filter is provided so as to correspond to this color dot. This color dot is supplied with image data of red color from the display source driver 3 via the source COLrj, thereby functioning as a red color dot.

Further, for a color dot driven by a thin-film transistor M1g connected to an intersection of the gate line GLi and the source line COLgj, a green color filter is provided so as to correspond to this color dot. This color dot is supplied with image data of green color from the display source driver 3 via the source line COLgj, thereby functioning as a green color dot.

Still further, for a color dot driven by a thin-film transistor M1b connected to an intersection of the gate line GLi and the source line COLbj, a blue color filter is provided so as to correspond to this color dot. This color dot is supplied with image data of blue color from the display source driver 3 via the source line COLbj, thereby functioning as a blue color dot.

It should be noted that in the example shown in FIG. 2, sensor circuits are provided so that one sensor circuit corresponds to one pixel (three color dots) in the pixel region 1. The ratio between the pixels and the sensor circuits provided, however, is not limited to this example, but is arbitrary. For example, one sensor circuit may be provided per one color dot, or one sensor circuit may be provided per a plurality of pixels.

The sensor circuit includes a photodiode D1, a capacitor C_{INT}, a thin-film transistor M2, a thin-film transistor M4, and a microswitch S1, as shown in FIG. 2. It should be noted that a PN-junction diode or a PIN junction diode having a lateral structure or a laminate structure, for example, can be used as the photodiode D1. As the microswitch S1, a transparent touch panel switch can be used that is formed with a conductive paste-printed contact or an ITO (indium tin oxide) transparent conductive film. It should be noted that the contact mechanism of the microswitch S1 in the present embodiment is of a vertical type (to be described later).

In the example shown in FIG. 2, the source line COLr also functions as the line VDD for supplying a constant voltage VDD to the optical sensor from the sensor column driver 4. Further, the source line COLg also functions as the line OUT for outputting a sensor output.

To an anode of the photodiode D1, which is the photodetecting element, the line RST (reset signal line) for supplying a reset signal is connected. To a cathode of the photodiode D1, a gate of the thin-film transistor M2, one of electrodes of the capacitor C_{INT}, and a drain of the thin-film transistor M4, which is a control switching element, are connected. At a junction point to which the gate of the thin-film transistor M2, the one of electrodes of the capacitor C_{INT}, and the drain of the thin-film transistor M4 are connected, the accumulation node is formed.

Regarding the thin-film transistor M2, which is the sensor switching element, a drain thereof is connected to the line VDD, and a source thereof is connected to the line OUT. Regarding the thin-film transistor M4, a source thereof is connected to one of the microswitch S1 (switch), and a gate thereof is connected to a line MODE. Further, an input electrode 50 connected to the other electrode of the microswitch S1 is connected to a counter electrode (VCOM). It should be noted that the line MODE is intended to supply a mode control signal that is used for controlling an operation mode, which will be described later.

The lines RST for supplying a reset signal and the lines RWS for supplying a readout signal (readout signal lines) are connected to the sensor row driver 5. These lines RST and RWS are provided per each row. Therefore, hereinafter, when the lines should be distinguished, they are denoted by RSTi and RWSi (i=1 to M).

The sensor row driver 5 selects the lines RSTi and RWSi in combination shown in FIG. 2 sequentially at predetermined time intervals (trow). With this, the rows of the optical sensors from which signal charges are to be read out are selected sequentially in the pixel region 1.

It should be noted that, as shown in FIG. 2, a drain of an insulated gate field effect transistor M3 is connected to an end of the line OUT. To the drain of the thin-film transistor M3, the output line SOUT is connected. Therefore, a potential VSOUT of the drain of the thin-film transistor M3 is output as an output signal from the sensor circuit, to the sensor column driver 4. A source of the thin-film transistor M3 is connected to the line VSS. A gate of the thin-film transistor M3 is connected to a reference voltage source (not shown) via a reference voltage line VB.

In the configuration of FIG. 2, signals are supplied to the line RST and the reset line RWS at predetermined timings, respectively, whereby a sensor output V_{PIX} according to an electric current flowing through the microswitch S1 and an amount of light received by the photodiode D1 can be obtained.

Here, an operation of the sensor circuit shown in FIG. 2 is explained. It should be noted that the sensor circuit according to the present embodiment is able to operate in three modes. The first one is an operation mode in which both of the optical sensor and the touch sensor function (hybrid mode), the second one is an operation mode in which only the optical sensor functions (imager mode), and the third one is an operation mode in which only the touch sensor functions (touch mode). These three modes can be switched from one to an arbitrary mode among these by controlling the above-described thin-film transistor M4 and the reset signal. Hereafter, each operation mode is explained. It should be noted that voltages set for the circuits shown below are merely examples, and may be changed appropriately depending on circuit constants based the design and performance of each device.

### [1-1. Hybrid Mode]

As an exemplary hybrid mode, a case where the microswitch S1 and the photodiode D1 are caused to function is explained hereinafter. In FIG. 2, when a high-level voltage is supplied to the line MODE, the thin-film transistor M4 thereby becomes conductive. The microswitch S1 is turned on by a touching operation.

(a) of FIG. 3A is a waveform diagram showing input signals supplied from the line MODE, the line RWS, and the line RST in the sensor circuit according to the present embodiment. (b) of FIG. 3A shows variation of the V_{INT} in response to the input signals. During an integration period T_{INT} after supply of the reset signal, the readout signal and the mode control signal are supplied from the line RWS and the line MODE, respectively, to the sensor circuit. In this case, if the microswitch S1 is in an ON state, charges having flowing into V_{INT} in response to the readout signal transfer to the counter electrode (VCOM) via the thin-film transistor M4 and the microswitch S1. This causes the potential of V_{INT} to become substantially equal to the potential of the counter electrode (VCOM), as indicated by F3 in (b) of FIG. 3A. The following description explains it in detail.

The sensor circuit according to the present embodiment is capable of amplifying and reading out variation of the potential of the accumulation node in the integration period T_{INT}, as shown in (b) of FIG. 3A. In the example shown in (a) of FIG. 3A, which is merely one embodiment, the reset signal has a low level V_{RST. L} of −7 V, and a high level V_{RST. H} of 0 V. The readout signal has a low level V_{RWS. L} of −3 V, and a high level V_{RWS. H} of 8 V. Further, the mode control signal has a low level V_{MODE. L} of 0 V and a high level V_{MODE. H} of 4 V.

First, when the high-level reset signal V_{RST. H} is supplied to the line RST, the photodiode D1 is forward-biased, and the potential V_{INT} of the gate of the thin-film transistor M2 is therefore expressed by the following formula (1):

V_{INT}=V_{RST. H}−V_{F} (1)

In the formula (1), V_{F} is a forward voltage of the photodiode D1. Since V_{INT} herein is lower than a threshold voltage of the thin-film transistor M2, the thin-film transistor M2 is non-conductive during a period while the high-level reset signal V_{RST. H} is being supplied. Here, the state where the high-level reset signal V_{RST. H} corresponds to a state where a reset voltage is applied.

Next, the reset signal returns to the low level V_{RST. L} (at the timing of t=T_{RST} in (b) of FIG. 3A), and thereby an electric current integration period (a sensing period that is a period after the supply of the reset signal before the supply of the readout signal, i.e., a period denoted by T_{INT} shown in (b) of FIG. 3A) starts. In the integration period, an electric current according to an amount of light incident on the photodiode D1 flows out of the capacitor C_{INT}, whereby the capacitor C_{INT} is discharged. Accordingly, the potential V_{INT} of the gate of the thin-film transistor M2 at the end of the integration period is expressed by the following formula (2):

V_{INT}=V_{RST. H}−V_{F}−ΔV_{RST}·C_{PD}/C_{T}−I_{PHOTO}·T_{INT}/C_{T} (2)

In the formula (2), ΔV_{RST} represents a height of a pulse of the reset signal (V_{RST. H}−V_{RST.L}), I_{PHOTO} represents a photoelectric current of the photodiode D1, and T_{INT} represents a duration of the integration period. C_{PD} represents a capacitance of the photodiode D1. C_{T} represents a sum of a capacitance of the capacitor C_{INT}, the capacitance C_{PD} of the photodiode D1, and a capacitance C_{TFT} of the thin-film transistor M2. During the integration period also, since the V_{INT} is lower than the threshold voltage of the thin-film transistor M2, the thin-film transistor M2 is non-conductive.

After the integration period ends, at the timing t=T_{RWS} shown in (b) of FIG. 3A, the readout signal rises (a readout voltage is applied), and the readout period thereby starts. It should be noted that the readout period continues while the readout signal remains at the high level. Further, the mode control signal rises at the same time when the readout signal rises, and the mode control signal continuously remains at the high level while the readout signal remains at the high level. In other words, during the readout period, since the mode control signal goes to the high level, the thin-film transistor M4 is conductive.

Here, a case where the microswitch S1 is in an OFF state (in a non-touched state) is explained. When the readout signal is supplied, the injection of charges into the capacitor C_{INT} occurs. The potential V_{INT} of the gate of the thin-film transistor M2 in this state is expressed by the following formula (3):

V_{INT}=V_{RST. H}−V_{F}−ΔV_{RST}·C_{PD}/C_{T}−I_{PHOTO}·T_{INT}/C_{T}+ΔV_{RWS}·C_{INT}/C_{T} (3)

ΔV_{RWS} is a height of a pulse of the readout signal (V_{RST. H}−V_{RWS. L}). With this, the potential V_{INT} of the gate of the thin-film transistor M2 becomes higher than the threshold voltage thereof, and this causes the thin-film transistor M2 to become conductive. Thus, the thin-film transistor M2, together with the thin-film transistor M3 provided at an end of the line OUT in each column, functions as a source-follower amplifier (amplification part). In other words, the sensor output voltage V_{PIX} from the thin-film transistor M2 is proportional to an integral of the photoelectric current of the photodiode D1 during the integration period.

On the other hand, a case where the microswitch S1 is in the ON state (in a touched state) is as explained below. As is the case with the above-described case, when the readout signal is supplied, the injection of charges to the capacitor C_{INT} occurs. However, since the microswitch S1 is connected to the counter electrode (VCOM), the charges of the capacitor C_{INT} transfer to the counter electrode (VCOM) side via the thin-film transistor M4 and the microswitch S1. As a result, the potential V_{INT} of the gate of the thin-film transistor M2 becomes substantially equal to the potential of the counter electrode (VCOM).

In this case, the thin-film transistor M2 becomes non-conductive. Therefore, the touched state (a state where the microswitch S1 is in the ON state) can be detected based on the absence of any sensor output from the thin-film transistor M2 during the sensing period.

In (b) of FIG. 3A, the waveform F1 indicated by a solid line represents variation of the potential V_{INT} in the case where the microswitch S1 is in the OFF state (in the non-touched state) and light incident on the photodiode D1 is small in amount. The waveform F2 indicated by a broken line represents variation of the potential V_{INT} in the case where the microswitch S1 is in the OFF state (in the non-touched state) and saturation-level light is incident on the photodiode D1. The waveform F3 indicated by another broken line represents variation of the potential V_{INT} in the case where the microswitch S1 is in the ON state (in the touched state) and saturation-level light is incident on the photodiode D1. ΔV_{INT} shown in (b) of FIG. 3A is an amount by which the potential V_{INT} is boosted by the application of the readout signal from the line RWS to the sensor circuit during the readout period.

As shown in (b) of FIG. 3A, during the readout period, the potential V_{INT} varies as indicated by the waveform F1 or the waveform F2 when the microswitch S1 is in the OFF state (in the non-touched state), whereas the potential V_{INT} varies as indicated by the waveform F3 when the microswitch S1 is in the ON state (in the touched state). Therefore, the potentials of F1, F2, and F3 during the readout period can be output as sensor outputs, respectively. Thus, the touched state and the non-touched state of the microswitch S1 and the amount of light received by the photodiode D1 can be detected.

As described above, in the present embodiment, the initialization by the reset pulse, the integration of an electric current during the integration period, and the readout of a sensor output during the readout period, which are assumed to constitute one cycle, are performed cyclically. By doing so, a floating state of charges that would cause the sensor output to be kept in an ON state can be avoided, and therefore, an output of the sensor circuit at each pixel can be obtained accurately.

### [1-2. Imager Mode]

As an exemplary imager mode, a case where the microswitch S1 is not caused to function and only the photodiode D1 is caused to function is explained hereinafter. In order to cause only the photodiode D1 to function, a high-level voltage is not supplied to the line MODE (i.e., a state where V_{MODE. L} is supplied is kept), as shown in (a) of FIG. 3B, whereby the thin-film transistor M4 is kept non-conductive. This makes an operation of the microswitch S1 ineffective.

When the readout signal is supplied, the injection of charges into the capacitor C_{INT} occurs. The potential V_{INT} of the gate of the thin-film transistor M2 in this state is expressed by the aforementioned formula (3). As is the case with the “hybrid mode” described above, the potential V_{INT} of the gate of the thin-film transistor M2 is made higher than the threshold voltage of the thin-film transistor M2 by ΔV_{RWS}, which makes the thin-film transistor M2 conductive. Thus, the thin-film transistor M2, together with the thin-film transistor M3 provided at an end of the line OUT in each column, functions as a source follower amplifier.

In (b) of FIG. 3B, the waveform F1 indicated by a solid line represents variation of the potential V_{INT} when the microswitch S1 is in the OFF state (in the non-touched state) and light incident on the photodiode D1 is small in amount. The waveform F2 indicated by a broken line represents variation of the potential V_{INT} in the non-touched state and in the case where light at a saturation level is incident on the photodiode D1. Like in the case where the microswitch S1 is turned off in the “hybrid mode” described above, the sensor output voltage V_{PIX} from the thin-film transistor M2 is proportional to an integral of the photoelectric current of the photodiode D1 during the integration period.

### [1-3. Touch Mode]

As an exemplary touch mode, a case where the photodiode D1 is not caused to function and only the microswitch S1 is caused to function is explained hereinafter. In order to cause only the microswitch S1 to function, a forward voltage of the photodiode D1 is prevented from being generated. As a method for preventing a forward voltage of the photodiode D1 from being generated, the low level V_{RST. L} and the high level V_{RST. H} of the reset signal may be set to the same voltage. For example, as shown in (a) of FIG. 3C, an output of a DC power source of 0 V may be used for the reset signal, whereby the photodiode D1 can be made ineffective. It should be noted that the photodiode D1 may be made ineffective by supplying the readout signal immediately after the supply of the reset signal so as to use, as the readout period, the timing when a forward voltage of the photodiode D1 is not generated.

As is the case with the “hybrid mode” described above, the thin-film transistor M4 is turned on by supplying the readout signal to the line RWS and at the same time, supplying the mode control signal to the line MODE. This is intended to avoid the junction node V_{INT} assuming a floating state thereby causing the thin-film transistor M3 to be kept in an ON state.

When the microswitch S1 is in the OFF state (in the non-touched state) upon the supply of the readout signal, the potential V_{INT} of the gate of the thin-film transistor M2 becomes higher than the threshold voltage, like when the microswitch S1 is in the OFF state in the above-described “hybrid mode”. This causes the thin-film transistor M2 to become conductive, and the thin-film transistor M2, together with the thin-film transistor M3 provided at an end of the line OUT in each column, functions as a source follower amplifier.

When the microswitch S1 is in the ON state (in the touched state) upon the supply of the readout signal, the injection of charges into the capacitor C_{INT} occurs in response to the readout signal, like when the microswitch S1 is in the ON state in the above-described “hybrid mode”. Since the microswitch S1 is, however, connected to the counter electrode (VCOM), charges in the capacitor C_{INT} transfer to the counter electrode (VCOM) side via the thin-film transistor M4 and the microswitch S1. As a result, the potential V_{INT} of the gate of the thin-film transistor M2 becomes substantially equal to the potential of the counter electrode (VCOM).

In this case, the thin-film transistor M2 becomes non-conductive. Therefore, based on the absence of any sensor output from the thin-film transistor M2 during the sensing period, the touched state can be detected.

In (b) of FIG. 3C, the waveform F1 indicated by the solid line represents variation of the potential V_{INT} in the case where the microswitch S1 is in the OFF state (in the non-touched state). F3 indicated by the broken line represents variation of the potential V_{INT} in the case where the microswitch S1 is in the ON state (in the touched state).

### [1-4. Structure of Sensor Circuit]

FIG. 4A shows an exemplary structure of a sensor circuit according to the present embodiment. As shown in FIG. 4A, this sensor circuit is formed on a glass substrate of an active matrix substrate, and includes a thin-film transistor M2 provided in a region between the source lines COLg and COLb. A photodiode D1 is a PIN diode having a lateral structure in which a p-type semiconductor region 102p, an i-type semiconductor region 102i, and an n-type semiconductor region 102n are formed in series in a silicon film as a base. The p-type semiconductor region 102p functions as an anode of the photodiode D1, and is connected to a line RST via a line 108 and contact holes 109 and 110. The n-type semiconductor region 102n functions as a cathode of the photodiode D1, and is connected to a gate electrode 101 of the thin-film transistor M2 via an extended portion 107 of the silicon film, contacts 105 and 106, and a line 104.

In this configuration, the lines RST and RWS are formed with the same metal as the metal of the gate electrode 101 of the thin-film transistor M2, and on the same layer through the same process as the layer and the process for the gate electrode 101. Besides, the lines 104, 108, 118, and 119 are formed with the same metal as the metal of the source line COL, and on the same layer through the same process as the layer and the process for the source line COL. On the backside of the photodiode D1, a light shielding film 113 for preventing backlight from being incident on the photodiode D1 is provided.

Further, as shown in FIG. 4A, the capacitor C_{INT} is formed with a wide portion 111 formed in the line RWS, the extended portion 107 of the silicon film forming the n-type semiconductor region 102n, and an insulation film (not shown) provided between the wide portion 111 and the extended portion 107. In other words, the wide portion 111 having substantially the same potential as that of the line RWS functions as one of electrodes of the capacitor C_{INT}.

Further, the thin-film transistor M4 is formed in a region between the extended portion 107 of the silicon film connected to the contact 106 and the line 119. The line MODE is connected to a gate electrode 115 of the thin-film transistor M4 via a line 118 and contact holes 116 and 117. The microswitch S1 is formed with an ITO 122 shown in FIG. 4A and a counter ITO (not shown) opposed to the ITO 122. The counter ITO is formed over an entirety of the surface of the counter substrate. This counter ITO is equivalent to a counter electrode (VCOM). As shown in FIG. 4A, the ITO 122 is connected to a source electrode of the thin-film transistor M4 via the line 119 and contact holes 120 and 121.

FIG. 4B shows an exemplary cross-sectional view of the microswitch S1. This microswitch S1 has an ITO 122 and a counter ITO 123, and the counter ITO 123 has a switch photospacer 124. When the microswitch S1 is subjected to a touching operation, the switch photospacer 124 is pressed down via a touch panel surface 125. This causes the ITO 122 and the counter ITO 123 to become conductive with each other, thereby causing the microswitch S1 to turn on. It should be noted that the microswitch S1 shown in FIG. 4B is a vertical-type switch since it is conductive in the vertical direction.

FIG. 4C shows an exemplary cross-sectional view of a microswitch S1 of another type. In this microswitch S1, an ITO 122 and a counter ITO 123 are arranged with a space therebetween. A lower surface of the switch photospacer 124 is formed with a conductive member 126. When the microswitch S1 is subjected to a touching operation, the switch photospacer 124 is pressed down via a touch panel surface 125. The ITO 122 and the counter ITO 123 therefore become conductive with each other via the conductive member 125, which causes the microswitch S1 to turn on. It should be noted that the microswitch shown in FIG. 4C is a horizontal-type switch since it is conductive in the horizontal direction.

### [1-5. Summary of First Embodiment]

As has been described so far, by controlling the thin-film transistor M4 by controlling the mode control signal supplied to the line MODE, the microswitch S1 can be controlled so that it is made effective or ineffective. Therefore, the optical sensor function based on the photodiode D1 and the touch sensor function based on the microswitch S1 can be used selectively. The selective use of the optical sensor function and the touch sensor function makes it possible to select a function corresponding to an application displayed on the display apparatus.

### 2. Second Embodiment

Hereinafter, Second Embodiment is explained. The members having the same functions as those of First Embodiment explained above are denoted by the same reference numerals as those in First Embodiment, and detailed explanations of the same are omitted. FIG. 5 is an equivalent circuit diagram of a sensor circuit according to the present embodiment. As shown in FIG. 5, the microswitch S1 of the sensor circuit according to the present embodiment is a horizontal-type switch in terms of the contact mechanism, in which an electrode thereof not connected with the thin-film transistor M4 is connected to the reference voltage line VB via the input electrode 50. The reference voltage line VB is provided not on the counter substrate side but on the active matrix substrate side, and a constant voltage (reference voltage) of 0 V from the reference voltage source (not shown) is supplied to the reference voltage line VB.

FIG. 6 shows a potential variation of V_{INT} when the sensor circuit according to the present embodiment operates in the “hybrid mode”. It should be noted that waveform diagrams showing input signals supplied from the line MODE, the line RWS, and the line RST, and waveforms of F1, F2, and F3 representing potential variations of V_{INT} are the same as those in First Embodiment in any one of the “hybrid mode”, the “imager mode”, and the “touch mode”. The sensor circuit according to the present embodiment, however, uses, not the counter electrode (VCOM), but the reference voltage line VB, and therefore, has an advantage that it is unnecessary to consider the timing of polarity inversion at the counter electrode. Therefore, when the sensor circuit according to the present embodiment is used, the degree of freedom in circuit designing can be improved.

### 3. Third Embodiment

Hereinafter, Third Embodiment is explained. The members having the same functions as those of First Embodiment explained above are denoted by the same reference numerals as those in First Embodiment, and detailed explanations of the same are omitted. FIG. 7 is an equivalent circuit diagram of a sensor circuit according to the present embodiment.

As shown in FIG. 7, the microswitch S1 of the sensor circuit according to the present embodiment is a horizontal-type switch in terms of the contact mechanism, in which one electrode thereof not connected with the thin-film transistor M4 is connected, via the input electrode 50, with the line RST for supplying the reset signal. Further, the control electrode of the thin-film transistor M4 is connected to the line MODE for supplying the mode control signal. The microswitch S1, when subjected to a touching operation, electrically connects the thin-film transistor M4 and the line RST with each other. In the present embodiment, the microswitch S1 is connected to the line RST, and therefore it is unnecessary to connect the microswitch S1 to the counter electrode (VCOM) or the reference voltage line VB as in First or Second Embodiment described above. Therefore, as compared with the configurations of First and Second Embodiments described above, the number of lines can be decreased. This simplifies the sensor circuit, and increases an aperture ratio.

### [3-1. Hybrid Mode]

An exemplary case where the sensor circuit according to the present embodiment is caused to operate in the hybrid mode is shown in FIG. 8A. (a) of FIG. 8A is a waveform diagram of a reset signal and a readout signal supplied to the sensor circuit according to the present embodiment. (b) of FIG. 8A is a waveform diagram showing a potential variation of V_{INT} in response to the above-described input signals.

The sensor circuit according to the present embodiment is capable of reading out an amplified variation of a potential of the accumulation node during the integration period T_{INT}, as shown in (b) of FIG. 8A. In the example shown in (a) of FIG. 8A, which is merely one embodiment, the reset signal has a low level V_{RST. L} of −7 V, and a high level V_{RST. H} of 0 V. The readout signal has a low level V_{RWS. L} of −3 V, and a high level V_{RWS. H} of 8 V. Further, the mode control signal has a low level V_{MODE. L} of −7 V, and a high level V_{MODE. H} of 0 V.

First, when the high-level reset signal V_{RST. H} is supplied from the line RST to the sensor circuit, the photodiode D1 is forward-biased. Here, since the mode control signal is at the low level, the thin-film transistor M4 is non-conductive. Therefore, the potential V_{INT} of the gate of the thin-film transistor M2 is expressed by a formula identical to the above-described formula (1). Here, since V_{INT} is lower than the threshold voltage of the thin-film transistor M2, the thin-film transistor M2 is non-conductive during a period while the high-level reset signal V_{RST. H} is being supplied.

Next, the reset signal returns to the low level V_{RST. L} (at the timing of t=T_{RST} in (b) of FIG. 8A), and thereby an electric current integration period (a sensing period that is a period after the supply of the reset signal before the supply of the readout signal, i.e., a period denoted by T_{INT} shown in (b) of FIG. 8A) starts. In the integration period, an electric current proportional to an amount of light incident on the photodiode D1 flows out of the capacitor C_{INT}, whereby the capacitor C_{INT} is discharged.

Here, the potential V_{INT} of the gate of the thin-film transistor M2 at the end of the integration period is determined by the above-described formula (2). During the integration period also, V_{INT} is lower than the threshold voltage of the thin-film transistor M2, and the thin-film transistor M2 is therefore non-conductive.

After the integration period ends, at the timing t=T_{RWS} shown in (b) of FIG. 8A, the readout signal rises, and the readout period thereby starts. It should be noted that the readout period continues while the readout signal remains at the high level. Further, the mode control signal rises at the same time when the readout signal rises, and the mode control signal continuously remains at the high level while the readout signal remains at the high level. In other words, during the readout period, since the mode control signal is at the high level, the thin-film transistor M4 is conductive.

Here, a case where the microswitch S1 is in an OFF state (in a non-touched state) is explained. When the readout signal is supplied, the injection of charges into the capacitor C_{INT} occurs. The potential V_{INT} of the gate of the thin-film transistor M2 in this state is expressed by the above-described formula (3). Thus, the potential V_{INT} of the gate of the thin-film transistor M2 becomes higher than the threshold voltage of the thin-film transistor M2, and this causes the thin-film transistor M2 to become conductive. Therefore, the thin-film transistor M2, together with the thin-film transistor M3 provided at an end of the line OUT in each column, functions as a source-follower amplifier. The sensor output voltage V_{INT} from the thin-film transistor M2 is proportional to an integral of the photoelectric current of the photodiode D1 during the integration period.

On the other hand, a case where the microswitch S1 is in an ON state (in a touched state) is explained below. As is the case with the above-described case, when the readout signal is supplied, the injection of charges to the capacitor C_{INT} occurs. However, since the microswitch S1 is connected to the line RST, the charges of the capacitor C_{INT} transfer to the line RST side via the thin-film transistor M4 and the microswitch S1. As a result, the potential V_{INT} of the gate of the thin-film transistor M2 becomes substantially equal to the potential (−7 V) of the line RST.

In this case, the thin-film transistor M2 becomes non-conductive. Therefore, the touched state can be detected based on the absence of any sensor output from the thin-film transistor M2 during the sensing period.

In (b) of FIG. 8A, the waveform F1 indicated by a solid line represents variation of the potential V_{INT} in the case where the microswitch S1 is in the OFF state (in the non-touched state) and light incident on the photodiode D1 is small in amount. The waveform F2 indicated by a broken line represents variation of the potential V_{INT} in the case where the microswitch S1 is in the OFF state (in the non-touched state) and saturation-level light is incident on the photodiode D1. Further, the waveform F3 indicated by another broken line represents variation of the potential V_{INT} in the case where the microswitch S1 is in the ON state (in the touched state) and saturation-level light is incident on the photodiode D1. ΔV_{INT} shown in (b) of FIG. 8A is an amount by which the potential V_{INT} is boosted when the readout signal from the line RWS is applied to the sensor circuit during the readout period.

As described above, in the present embodiment, even when the readout signal is applied from the line RWS, charges injected into the capacitor C_{INT} transfer to the line RST side via the microswitch S1 in the ON state, and therefore, the potential of V_{INT} does not rise even during the readout period. Consequently, a floating state of charges that would cause the sensor output to be kept in an ON state can be avoided, and therefore, an output of the sensor circuit at each pixel can be obtained accurately.

### [3-2. Imager Mode]

In order to cause only the photodiode D1 to function, the voltage of the line MODE is kept at the same level as the low level V_{RST. L} of the reset signal (i.e., a state where V_{MODE. L} is supplied is kept), as shown in (a) of FIG. 8B, whereby the thin-film transistor M4 is kept non-conductive. This makes an operation of the microswitch S1 ineffective.

When the readout signal is supplied, the injection of charges into the capacitor C_{INT} occurs. The potential V_{INT} of the gate of the thin-film transistor M2 in this state is expressed by the above-described formula (3). As is the case with the “hybrid mode” described above, the potential V_{INT} of the gate of the thin-film transistor M2 is made higher than the threshold voltage of the thin-film transistor M2 by ΔV_{RWS}, which makes the thin-film transistor M2 conductive. Thus, the thin-film transistor M2, together with the thin-film transistor M3 provided at an end of the line OUT in each column, functions as a source follower amplifier.

In (b) of FIG. 8B, the waveform F1 indicated by a solid line represents variation of the potential V_{INT} when the microswitch S1 is in the OFF state (in the non-touched state) and light incident on the photodiode D1 is small in amount. The waveform F2 indicated by a broken line represents variation of the potential V_{INT} when the microswitch S1 is in the OFF state (in the non-touched state) and light at a saturation level is incident on the photodiode D1.

Like when the microswitch S1 is in the OFF state in the “hybrid mode” described above, the sensor output voltage V_{PIX} from the thin-film transistor M2 is proportional to an integral of the photoelectric current of the photodiode D1 during the integration period.

### [3-3. Touch Mode]

In order to cause only the microswitch S1 to function, a forward voltage of the photodiode D1 is prevented from being generated. As a method for preventing a forward voltage of the photodiode D1 from being generated, the low level V_{RST. L} and the high level V_{RST. H} of the reset signal may be set to the same voltage. For example, as shown in (a) of FIG. 8C, an output of 0 V of a DC power source may be used for the reset signal, whereby the photodiode D1 can be made ineffective. It should be noted that the photodiode D1 may be made ineffective by supplying the readout signal immediately after the supply of the reset signal so as to use, as the readout period, the timing when a forward voltage of the photodiode D1 is not generated.

In this case, as is the case with the “hybrid mode” described above, the thin-film transistor M4 has to be turned on by supplying the readout signal to the line RWS and at the same time, supplying the mode control signal to the line MODE. This is intended to avoid the junction node V_{INT} assuming a floating state.

When the microswitch S1 is in the OFF state (in the non-touched state), the potential V_{INT} of the gate of the thin-film transistor M2 becomes higher than the threshold voltage of the thin-film transistor M2, like when the microswitch S1 is in the OFF state in the above-described “hybrid mode”. This causes the thin-film transistor M2 to become conductive, and the thin-film transistor M2, together with the thin-film transistor M3 provided at an end of the line OUT in each column, functions as a source follower amplifier.

When the microswitch S1 is in the ON state (in the touched state), the injection of charges into the capacitor C_{INT} occurs upon the supply of the readout signal, like when the microswitch S1 is in the ON state in the above-described “hybrid mode”. Since the microswitch S1 is, however, connected to the line RST, charges in the capacitor C_{INT} transfer to the line RST side via the thin-film transistor M4 and the microswitch S1. As a result, the potential V_{INT} of the gate of the thin-film transistor M2 becomes substantially equal to the voltage of the reset signal line.

In this case, the thin-film transistor M2 becomes non-conductive. Therefore, based on the absence of any sensor output from the thin-film transistor M2 during the sensing period, the touched state can be detected.

In (b) of FIG. 8C, the waveform F1 indicated by a solid line represents variation of the potential V_{INT} in the case where the microswitch S1 is in the OFF state (in the non-touched state). The waveform F3 indicated by a broken line represents variation of the potential V_{INT} in the case where the microswitch S1 is in the ON state (in the touched state).

### 4. Fourth Embodiment

Hereinafter, Fourth Embodiment is explained. The members having the same functions as those of First Embodiment explained above are denoted by the same reference numerals as those in First Embodiment, and detailed explanations of the same are omitted. FIG. 9 is an equivalent circuit diagram of a sensor circuit according to the present embodiment.

As shown in FIG. 9, the microswitch S1 of the sensor circuit according to the present embodiment is a horizontal-type switch in terms of the contact mechanism, in which an electrode thereof not connected with the thin-film transistor M4 is connected to the line RWS via the input electrode 50. A control electrode of the thin-film transistor M4 is connected to the line MODE for supplying the mode control signal. The microswitch S1, when subjected to a touching operation, electrically connects the thin-film transistor M4 and the line RWS with each other. In the present embodiment, by connecting the microswitch S1 to the line RWS, the number of lines can be decreased as compared with the configurations of First and Second Embodiments, as is the case with Third Embodiment. This simplifies the sensor circuit, and increases an aperture ratio.

### [4-1. Hybrid Mode]

An exemplary case where the sensor circuit according to the present embodiment is caused to operate in the hybrid mode is shown in FIG. 10A. (a) of FIG. 10A is a waveform diagram of a reset signal and a readout signal supplied to the sensor circuit according to the present embodiment. (b) of FIG. 10A is a waveform diagram showing potential variation of V_{INT} in response to the above-described input signals.

The sensor circuit according to the present embodiment is capable of reading out an amplified variation of a potential of the accumulation node during the integration period T_{INT}, as shown in (b) of FIG. 10A. In the example shown in (a) of FIG. 10, which is merely one embodiment, the reset signal has a low level V_{RST. L} of −7 V, and a high level V_{RST. H} of 0 V. The readout signal has a low level V_{RWS. L} of −3 V, and a high level V_{RWS. H} of 8 V. Further, the mode control signal has a low level V_{MODE. L} of −7 V, and a high level V_{MODE. H} of 0 V.

First, when the high-level reset signal V_{RST. H} is supplied from the line RST to the sensor circuit, the photodiode D1 is forward-biased. Here, since the mode control signal is at the low level, the thin-film transistor M4 is non-conductive. Therefore, the potential V_{INT} of the gate of the thin-film transistor M2 is therefore expressed by a formula identical to the above-described formula (1). Here, since V_{INT} is lower than the threshold voltage of the thin-film transistor M2, the thin-film transistor M2 is non-conductive during a period while the high-level reset signal V_{RST. H} is being supplied.

Next, the reset signal returns to the low level V_{EST. L} (at the timing of t=T_{RST} in (b) of FIG. 10A), and thereby an electric current integration period (a sensing period that is a period after the supply of the reset signal before the supply of the readout signal, i.e., a period denoted by T_{INT} shown in (b) of FIG. 10A) starts. In the integration period, an electric current proportional to an amount of light incident on the photodiode D1 flows out of the capacitor C_{INT}, whereby the capacitor C_{INT} is discharged.

Here, the potential V_{INT} of the gate of the thin-film transistor M2 at the end of the integration period is determined by the above-described formula (2). During the integration period also, V_{INT} is lower than the threshold voltage of the thin-film transistor M2, and the thin-film transistor M2 is therefore non-conductive.

After the integration period ends, at the timing t=T_{RWS} shown in (b) of FIG. 10A, the readout signal rises, and the readout period thereby starts. It should be noted that the readout period continues while the readout signal remains at the high level. Further, the mode control signal rises at the same time when the readout signal rises, and the mode control signal continuously remains at the high level while the readout signal remains at the high level. In other words, during the readout period, since the mode control signal is at the high level, the thin-film transistor M4 is conductive.

Here, a case where the microswitch S1 is in the OFF state (in the non-touched state) is explained. When the readout signal is supplied, the injection of charges into the capacitor C_{INT} occurs. As a result, the potential V_{INT} of the gate of the thin-film transistor M2 is expressed by the above-described formula (3). Thus, the potential V_{INT} of the gate of the thin-film transistor M2 becomes higher than the threshold voltage of the thin-film transistor M2, and this causes the thin-film transistor M2 to become conductive. Therefore, the thin-film transistor M2, together with the thin-film transistor M3 provided at an end of the line OUT in each column, functions as a source-follower amplifier. The sensor output voltage V_{PIX} from the thin-film transistor M2 is proportional to an integral of the photoelectric current of the photodiode D1 during the integration period.

On the other hand, a case where the microswitch S1 is in the ON state (in the touched state) is explained below. Since the microswitch S1 is connected to the line RWS, when the readout signal is supplied, the potential V_{INT} of the gate of the thin-film transistor M2 is boosted up via the microswitch S1 and the thin-film transistor M4. Therefore, the potential V_{INT} of the gate of the thin-film transistor M2 has a value obtained by subtracting the threshold voltage of the thin-film transistor M4 from the high level V_{RWS. H} of the readout signal.

In this case, the potential V_{INT} of the gate of the thin-film transistor M2 is higher than the threshold voltage of the thin-film transistor M2, and the thin-film transistor M2 therefore becomes conductive. As a result, the thin-film transistor M2, together with the thin-film transistor M3 provided at an end of the line OUT in each column, functions as a source-follower amplifier. In other words, the sensor output voltage V_{PIX} from the thin-film transistor M2 coincides with a value obtained by subtracting the threshold voltage of the thin-film transistor M4 from a supplied voltage of the readout signal.

In (b) of FIG. 10A, the waveform F1 indicated by a solid line represents variation of the potential V_{INT} in the case where the microswitch S1 is in the OFF state (in the non-touched state) and light incident on the photodiode D1 is small in amount. The waveform F2 indicated by a broken line represents variation of the potential Vita in the case where the microswitch S1 is in the OFF state (in the non-touched state) and saturation-level light is incident on the photodiode D1. Further, the waveform F3 indicated by another broken line represents variation of the potential V_{INT} in the case where the microswitch S1 is in the ON state (in the touched state). ΔV_{INT} shown in (b) of FIG. 10A is an amount by which the potential V_{INT} is boosted when the readout signal from the line RWS is applied to the sensor circuit during the readout period.

As described above, in the present embodiment, when the readout signal is applied from the line RWS, the potential of V_{INT} to is caused to rise via the microswitch S1 in the ON state. After the readout period, the readout signal returns to the low level V_{RWS. L}, and charges flow from V_{INT} into the capacitor C_{INT}. Consequently, a floating state of charges that would cause the sensor output to be kept in an ON state can be avoided, and therefore, an output of the sensor circuit at each pixel can be obtained accurately.

As shown in (b) of FIG. 10A, in the sensor circuit according to the present embodiment, the potential of V_{INT} in the touched state (waveform F3) is greater than the potential of V_{INT} when light incident on the photodiode D1 is small in amount (waveform F1). Based on this, the touched state can be detected. It should be noted that a difference ΔV_{F3-F1} between the waveform F3 and the waveform F1 during the readout period, shown in (b) of FIG. 10A, coincides with an integral of a dark current in the photodiode D1.

### [4-2. Imager Mode]

In order to cause only the photodiode D1 to function, the voltage of the line MODE is kept at the same level as the low level V_{RST. L} of the reset signal (i.e., a state where V_{MODE. L} is supplied is kept), as shown in (a) of FIG. 10B. This makes it possible to keep the thin-film transistor M4 non-conductive. This makes an operation of the microswitch S1 ineffective.

When the readout signal is supplied, the injection of charges into the capacitor C_{INT} occurs. The potential V_{INT} of the gate of the thin-film transistor M2 in this state is expressed by the above-described formula (3). As is the case with the “hybrid mode” described above, the potential V_{INT} of the gate of the thin-film transistor M2 is made higher than the threshold voltage of the thin-film transistor M2 by ΔV_{RWS}, which makes the thin-film transistor M2 conductive. Thus, the thin-film transistor M2, together with the thin-film transistor M3 provided at an end of the line OUT in each column, functions as a source follower amplifier.

In (b) of FIG. 10B, the waveform F1 indicated by a solid line represents variation of the potential V_{INT} when light incident on the photodiode D1 is small in amount. The waveform F2 indicated by a broken line represents variation of the potential V_{INT} when light at a saturation level is incident on the photodiode D1.

Like when the microswitch S1 is in the OFF state in the “hybrid mode” described above, the sensor output voltage V_{PIX} from the thin-film transistor M2 is proportional to an integral of the photoelectric current of the photodiode D1 during the integration period.

### [4-3. Touch Mode]

In order to cause only the microswitch S1 to function, a forward voltage of the photodiode D1 is prevented from being generated. As a method for preventing a forward voltage of the photodiode D1 from being generated, the low level V_{RST. L} and the high level V_{RST. H} of the reset signal may be set to the same voltage. For example, as shown in (a) of FIG. 10C, the reset signal may be set to 0 V of a DC power source, whereby the photodiode D1 can be made ineffective. It should be noted that the photodiode D1 may be made ineffective by supplying the readout signal immediately after the supply of the reset signal so as to use, as the readout period, the timing when a forward voltage of the photodiode D1 is not generated.

In this case, as is the case with the “hybrid mode” described above, the thin-film transistor M4 has to be turned on by supplying the readout signal to the line RWS and at the same time, supplying the mode control signal to the line MODE. This is intended to avoid the junction node V_{INT} assuming a floating state.

When the microswitch S1 is in the OFF state (in the non-touched state), the potential V_{INT} of the gate of the thin-film transistor M2 becomes higher than the threshold voltage thereof, like when the microswitch S1 is in the OFF state in the above-described “hybrid mode”. This causes the thin-film transistor M2 to become conductive, and the thin-film transistor M2, together with the thin-film transistor M3 provided at an end of the line OUT in each column, functions as a source follower amplifier.

When the microswitch S1 is in the ON state (in the touched state), the potential V_{INT} of the gate of the thin-film transistor M2 is boosted up upon the supply of the readout signal, like when the microswitch S1 is in the ON state in the “hybrid mode” described above. More specifically, since the microswitch S1 is connected to the line RWS, when the readout signal is supplied, the potential V_{INT} of the gate of the thin-film transistor M2 is boosted up via the microswitch S1 and the thin-film transistor M4. Therefore, the potential V_{INT} of the gate of the thin-film transistor M2 has a value obtained by subtracting the threshold voltage of the thin-film transistor M4 from the high level V_{RWS. H} of the readout signal.

In this case, the thin-film transistor M2 becomes conductive, since the potential V_{INT} of the gate of the thin-film transistor M2 is higher than the threshold voltage of the thin-film transistor M2. Therefore, the thin-film transistor M2, together with the thin-film transistor M3 provided at an end of the line OUT in each column, functions as a source follower amplifier. In other words, the sensor output voltage V_{PIX} from the thin-film transistor M2 coincides with a value obtained by subtracting the threshold voltage of the thin-film transistor M4 from a supplied voltage of the readout signal.

In (b) of FIG. 10C, the waveform F1 indicated by a solid line represents variation of the potential V_{INT} in the case where the microswitch S1 is in the OFF state (in the non-touched state). The waveform F3 indicated by a broken line represents variation of the potential V_{INT} in the case where the microswitch S1 is in the ON state (in the touched state).

### 5. Fifth Embodiment

Hereinafter, Fifth Embodiment is explained. The members having the same functions as those of First Embodiment explained above are denoted by the same reference numerals as those in First Embodiment, and detailed explanations of the same are omitted. FIG. 11 is an equivalent circuit diagram of a sensor circuit according to the present embodiment.

As shown in FIG. 11, the microswitch S1 of the sensor circuit according to the present embodiment is a vertical-type switch in terms of the contact mechanism, in which an electrode thereof not connected with the thin-film transistor M4 is connected to a counter electrode (VCOM) via the input electrode 50. A control electrode of the thin-film transistor M4 is connected to the line RWS. The microswitch S1, when subjected to a touching operation, electrically connects the thin-film transistor M4 and the counter electrode (VCOM) with each other. In the present embodiment, by connecting the control electrode of the thin-film transistor M4 to the line RWS, the number of lines can be decreased as compared with the configurations of First Embodiment. This simplifies the sensor circuit, and increases an aperture ratio.

### [5-1. Hybrid Mode]

An exemplary case where the sensor circuit according to the present embodiment is caused to operate in the hybrid mode is shown in FIG. 12A. (a) of FIG. 12A is a waveform diagram of a reset signal and a readout signal supplied to the sensor circuit according to the present embodiment. (b) of FIG. 12A is a waveform diagram showing potential variation of V_{INT} in response to the above-described input signals.

The sensor circuit according to the present embodiment is capable of reading out an amplified variation of a potential of the accumulation node during the integration period T_{INT}, as shown in (b) of FIG. 12A. In the example shown in (a) of FIG. 12A, which is merely one embodiment, the reset signal has a low level V_{RST. L} of −7 V, and a high level V_{RST. H} of 0 V. The readout signal has a low level V_{RWS. L} of −7 V, and a high level V_{RWS. H} of 8 V. It should be noted that there is no signal input from a line MODE to the sensor circuit in the present embodiment since the mode control signal is not used.

First, when the high-level reset signal V_{EST. H} is supplied from the line RST to the sensor circuit, the photodiode D1 is forward-biased. Therefore, the potential V_{INT} of the gate of the thin-film transistor M2 is therefore expressed by a formula identical to the above-described formula (1). Here, since V_{INT} is lower than the threshold voltage of the thin-film transistor M2, the thin-film transistor M2 is non-conductive during a period while the high-level reset signal V_{RST. H} is being supplied.

Next, the reset signal returns to the low level V_{EST. L} (at the timing of t=T_{RST} in (b) of FIG. 12A), and thereby an electric current integration period (a sensing period that is a period after the supply of the reset signal before the supply of the readout signal, i.e., a period denoted by T_{INT} shown in (b) of FIG. 12A) starts. In the integration period, an electric current proportional to an amount of light incident on the photodiode D1 flows out of the capacitor C_{INT}, whereby the capacitor C_{INT} is discharged.

Here, the potential V_{INT} of the gate of the thin-film transistor M2 at the end of the integration period is determined by the above-described formula (2). During the integration period also, V_{INT} is lower than the threshold voltage of the thin-film transistor M2, and the thin-film transistor M2 is therefore non-conductive.

After the integration period ends, at the timing t=T_{RWS} shown in (b) of FIG. 12A, the readout signal rises, and the readout period thereby starts. It should be noted that the readout period continues while the readout signal remains at the high level. In other words, during the readout period, since the readout signal rises, the thin-film transistor M4 is conductive. Then, after the readout period is over, the thin-film transistor M4 becomes non-conductive, and therefore the photodiode D1 functions alone.

Here, a case where the microswitch S1 is in an OFF state (in a non-touched state) is explained. When the sensor circuit is supplied with the readout signal, the injection of charges into the capacitor C_{INT} occurs. Here, a voltage is supplied to the control electrode of the thin-film transistor M4 by the readout signal, but since the microswitch S1 is in the OFF state, the operation of the thin-film transistor M4 does not assume influence on the potential V_{INT}. The potential V_{INT} of the gate of the thin-film transistor M2 in this state is expressed by the above-described formula (3). Thus, the potential V_{INT} of the gate of the thin-film transistor M2 becomes higher than the threshold voltage of the thin-film transistor M2, and this causes the thin-film transistor M2 to become conductive. The thin-film transistor M2, together with the thin-film transistor M3 provided at an end of the line OUT in each column, functions as a source-follower amplifier. In other words, the sensor output voltage V_{PIX} from the thin-film transistor M2 is proportional to an integral of the photoelectric current of the photodiode D1 during the integration period.

On the other hand, a case where the microswitch S1 is in an ON state (in a touched state) is explained below. As is the case with the above-described case where the microswitch S1 is in the OFF state, when the readout signal is supplied, the injection of charges to the capacitor C_{INT} occurs. However, since the microswitch S1 is connected to the counter electrode (VCOM), the charges of the capacitor C_{INT} transfer to the counter electrode (VCOM) side via the thin-film transistor M4 and the microswitch S1. As a result, the potential V_{INT} of the gate of the thin-film transistor M2 becomes substantially equal to the potential (0 V) of the counter electrode (VCOM).

In this case, the thin-film transistor M2 becomes non-conductive, since the potential V_{INT} of the gate of the thin-film transistor M2 becomes substantially equal to the potential of the line RST. Therefore, the touched state can be detected based on the absence of any sensor output from the thin-film transistor M2 during the sensing period.

In (b) of FIG. 12A, the waveform F1 indicated by a solid line represents variation of the potential V_{INT} in the case where the microswitch S1 is in the OFF state (in the non-touched state) and light incident on the photodiode D1 is small in amount. The waveform F2 indicated by a broken line represents variation of the potential V_{INT} in the case where the microswitch S1 is in the OFF state (in the non-touched state) and saturation-level light is incident on the photodiode D1. Further, the waveform F3 indicated by another broken line represents variation of the potential V_{INT} in the case where the microswitch S1 is in the ON state (in the touched state) and saturation-level light is incident on the photodiode D1. ΔV_{INT} shown in (b) of FIG. 12A is an amount by which the potential V_{INT} is boosted when the readout signal from the line RWS is applied to the sensor circuit during the readout period.

As described above, in the present embodiment, even when the readout signal is applied from the line RWS, charges injected into the capacitor C_{INT} transfer to the counter electrode (VCOM) side via the microswitch S1 in the ON state, and therefore the potential of V_{INT} does not rise even during the readout period. Consequently, a floating state of charges that would cause the sensor output to be kept in an ON state can be avoided, and therefore, an output of the sensor circuit at each pixel can be obtained accurately.

### [5-2. Imager Mode]

In order to cause only the photodiode D1 to function, the following setting is provided as shown in (a) of FIG. 12B, which, however, is merely one embodiment: the low level V_{RST. L} and the high level V_{RST. H} of the reset signal are set to −7 V and 0 V, respectively, and the low level V_{RWS. L} and the high level V_{RWS. H} of the readout signal are set to −15 V and 0V, respectively. With this setting of the read out signal, the thin-film transistor M4 can be kept non-conductive. In other words, since the potential owing to the readout signal does not rise to over the threshold value of the thin-film transistor M4, an operation of the microswitch S1 can be made ineffective.

When the readout signal is supplied, the injection of charges into the capacitor C_{INT} occurs. The potential V_{INT} of the gate of the thin-film transistor M2 in this state is expressed by the above-described formula (3). As is the case with the “hybrid mode” described above, the potential V_{INT} of the gate of the thin-film transistor M2 is made higher than the threshold voltage of the thin-film transistor M2 by ΔV_{RWS}, which makes the thin-film transistor M2 conductive. Thus, the thin-film transistor M2, together with the thin-film transistor M3 provided at an end of the line OUT in each column, functions as a source follower amplifier.

In (b) of FIG. 12B, the waveform F1 indicated by a solid line represents variation of the potential V_{INT} when light incident on the photodiode D1 is small in amount. The waveform F2 indicated by a broken line represents variation of the potential V_{INT} when light at a saturation level is incident on the photodiode D1.

Like when the microswitch S1 is in the OFF state in the “hybrid mode” described above, the sensor output voltage V_{PIX} from the thin-film transistor M2 is proportional to an integral of the photoelectric current of the photodiode D1 during the integration period.

### [5-3. Touch Mode]

In order to cause only the microswitch S1 to function, a forward voltage of the photodiode D1 is prevented from being generated. In the present embodiment, since a DC power source output is not used as the reset signal, the readout signal is supplied immediately after the reset signal is supplied, so that a forward voltage of the photodiode D1 should not be generated. Thus, the timing at which a forward voltage of the photodiode D1 is not generated is utilized as the readout period, whereby the photodiode D1 is made ineffective.

The following setting is provided as shown in (a) of FIG. 12C, which, however, is merely one embodiment: the low level V_{RST. L} and the high level V_{RST. H} of the reset signal are set to −7 V and 0 V, respectively, and the low level V_{RWS. L} and the high level V_{RWS. H} of the readout signal are set to −7 V and 8 V, respectively.

When the microswitch S1 is in the OFF state (in the non-touched state), the potential V_{INT} of the gate of the thin-film transistor M2 becomes higher than the threshold voltage of the thin-film transistor M2, like when the microswitch S1 is in the OFF state in the above-described “hybrid mode”. This causes the thin-film transistor M2 to become conductive, and the thin-film transistor M2, together with the thin-film transistor M3 provided at an end of the line OUT in each column, functions as a source follower amplifier.

When the microswitch S1 is in the ON state (in the touched state), the injection of charges into the capacitor C_{INT} occurs upon the supply of the readout signal, like when the microswitch S1 is in the ON state in the above-described “hybrid mode”. However, since the microswitch S1 is connected to the counter electrode (VCOM), the charges of the capacitor C_{INT} transfer to the counter electrode (VCOM) side via the thin-film transistor M4 and the microswitch S1. As a result, the potential V_{INT} of the gate of the thin-film transistor M2 becomes substantially equal to the voltage of the counter electrode (VCOM).

In this case, the thin-film transistor M2 becomes non-conductive, since the potential V_{INT} of the gate of the thin-film transistor M2 is substantially equal to that of the counter electrode (VCOM). Therefore, the touched state can be detected based on the absence of any sensor output from the thin-film transistor M2 during the sensing period.

In (b) of FIG. 12C, the waveform F1 indicated by a solid line represents variation of the potential V_{INT} in the case where the microswitch S1 is in the OFF state (in the non-touched state). The waveform F3 indicated a broken line represents variation of the potential V_{INT} in the case where the microswitch S1 is in the ON state (in the touched state).

### 6. Sixth Embodiment

Hereinafter, Sixth Embodiment is explained. The members having the same functions as those of First Embodiment explained above are denoted by the same reference numerals as those in First Embodiment, and detailed explanations of the same are omitted. FIG. 13 is an equivalent circuit diagram of a sensor circuit according to the present embodiment.

As shown in FIG. 13, the microswitch S1 of the sensor circuit according to the present embodiment is different from that of Fifth Embodiment in that the microswitch S1 is a horizontal-type switch in terms of the contact mechanism, and in that an electrode of the microswitch D1 not connected with the thin-film transistor M4 is connected to a reference voltage line VB via the input electrode 50. It should be noted that a constant voltage of 0 V from a reference voltage source (not shown) is supplied to the reference voltage line VB.

FIG. 14 shows potential variation of V_{INT} in the case where the sensor circuit according to the present embodiment operates in the “hybrid mode”. It should be noted that the waveforms F1, F2, and F3 showing potential variations of V_{INT} are identical to those of Fifth Embodiment in any one of the “hybrid mode”, the “imager mode” and the “touch mode”.

The sensor circuit according to the present embodiment, which uses not the counter electrode (VCOM) but the reference voltage line VB, has an advantage that it is unnecessary to consider the timing of polarity inversion at the counter electrode. Therefore, when the sensor circuit according to the present embodiment is used, the degree of freedom in circuit designing can be improved.

### 7. Seventh Embodiment

Hereinafter, Seventh Embodiment is explained. The members having the same functions as those of First Embodiment explained above are denoted by the same reference numerals as those in First Embodiment, and detailed explanations of the same are omitted. FIG. 15 is an equivalent circuit diagram of a sensor circuit according to the present embodiment.

As shown in FIG. 15, the microswitch S1 of the sensor circuit according to the present embodiment is a horizontal-type switch in terms of the contact mechanism, in which one electrode thereof not connected with the thin-film transistor M4 is connected to the line RWS via the input electrode 50. Further, in the sensor circuit according to the present embodiment, the control electrode of the thin-film transistor M4 is connected to the line RWS.

The microswitch S1, upon a touching operation, electrically connects the thin-film transistor M4 and the line RWS with each other. In the present embodiment, the microswitch S1 and the control electrode of the thin-film transistor M4 are connected to the line RST, whereby the number of lines can be decreased as compared with the configuration of First Embodiment. This simplifies the sensor circuit, and increases an aperture ratio.

### [7-1. Hybrid Mode]

An exemplary case where the sensor circuit according to the present embodiment is caused to operate in the hybrid mode is shown in FIG. 16A. (a) of FIG. 16A is a waveform diagram of a reset signal and a readout signal supplied to the sensor circuit according to the present embodiment. (b) of FIG. 16A is a waveform diagram showing potential variation of V_{INT} in response to the above-described input signals.

The sensor circuit according to the present embodiment is capable of reading out an amplified variation of a potential of the accumulation node during the integration period T_{INT}, as shown in (b) of FIG. 16A. In the example shown in (a) of FIG. 16A, which is merely one embodiment, the reset signal has a low level V_{RST. L} of −7 V, and a high level V_{EST H} of 0 V. The readout signal has a low level V_{RWS. L} of −7 V, and a high level V_{RWS. H} of 8 V. It should be noted that in the present embodiment, there is no signal input from a line MODE to the sensor circuit, since the mode control signal is not used.

First, when the high-level reset signal V_{EST. H} is supplied to the line RST, the photodiode D1 is forward-biased, and therefore, the potential V_{INT} of the gate of the thin-film transistor M2 is expressed by a formula identical to the above-described formula (1). Here, since V_{INT} is lower than the threshold voltage of the thin-film transistor M2, the thin-film transistor M2 is non-conductive during a period while the high-level reset signal V_{RST. H} is being supplied.

Next, the reset signal returns to the low level V_{RST. L} (at the timing of t=T_{RST} in (b) of FIG. 16A), and thereby an electric current integration period (a sensing period that is a period after the supply of the reset signal before the supply of the readout signal, i.e., a period denoted by T_{INT} shown in (b) of FIG. 16A) starts. In the integration period, an electric current proportional to an amount of light incident on the photodiode D1 flows out of the capacitor C_{INT}, whereby the capacitor C_{INT} is discharged.

Here, the potential V_{INT} of the gate of the thin-film transistor M2 at the end of the integration period is determined by the above-described formula (2). During the integration period also, V_{INT} is lower than the threshold voltage of the thin-film transistor M2, and the thin-film transistor M2 is therefore non-conductive.

After the integration period ends, at the timing t=T_{RWS} shown in (b) of FIG. 16A, the readout signal rises, and the readout period thereby starts. It should be noted that the readout period continues while the readout signal remains at the high level. In other words, during the readout period, since the readout signal is at the high level, the thin-film transistor M4 is conductive. After the readout period is over, the thin-film transistor M4 becomes non-conductive, whereby in the sensor circuit the photodiode D1 functions alone.

Here, a case where the microswitch S1 is in an OFF state (in a non-touched state) is explained. When the readout signal is supplied, the injection of charges into the capacitor C_{INT} occurs. Here, a voltage is supplied to the control electrode of the thin-film transistor M4 by the readout signal, but since the microswitch S1 is in the OFF state, the operation of the thin-film transistor M4 does not assume influence on the potential of V_{INT}. The potential V_{INT} of the gate of the thin-film transistor M2 in this state is expressed by the above-described formula (3). Thus, the potential V_{INT} of the gate of the thin-film transistor M2 becomes higher than the threshold voltage of the thin-film transistor M2, and this causes the thin-film transistor M2 to become conductive. Therefore, the thin-film transistor M2, together with the thin-film transistor M3 provided at an end of the line OUT in each column, functions as a source-follower amplifier. In other words, the sensor output voltage V_{PIX} from the thin-film transistor M2 is proportional to an integral of the photoelectric current of the photodiode D1 during the integration period.

On the other hand, a case where the microswitch S1 is in an ON state (in a touched state) is explained below. When the readout signal is supplied, since the microswitch S1 is connected to the line RWS, the potential V_{INT} of the gate of the thin-film transistor M2 is boosted up via the microswitch S1 and the thin-film transistor M4. Therefore, the potential V_{INT} of the gate of the thin-film transistor M2 has a value obtained by subtracting the threshold voltage of the thin-film transistor M4 from the high level V_{RWS. H} of the readout signal.

In this case, the potential V_{INT} of the gate of the thin-film transistor M2 is higher than the threshold voltage of the thin-film transistor M2, and the thin-film transistor M2 therefore becomes conductive. As a result, the thin-film transistor M2, together with the thin-film transistor M3 provided at an end of the line OUT in each column, functions as a source-follower amplifier. In other words, the sensor output voltage V_{PIX} from the thin-film transistor M2 coincides with a value obtained by subtracting the threshold voltage of the thin-film transistor M4 from a supplied voltage of the readout signal.

In (b) of FIG. 16A, the waveform F1 indicated by a solid line represents variation of the potential V_{INT} in the case where the microswitch S1 is in the OFF state (in the non-touched state) and light incident on the photodiode D1 is small in amount. The waveform F2 indicated by a broken line represents variation of the potential V_{INT} in the case where the microswitch S1 is in the OFF state (in the non-touched state) and saturation-level light is incident on the photodiode D1. Further, the waveform F3 indicated by another broken line represents variation of the potential V_{INT} in the case where the microswitch S1 is in the ON state (in the touched state). ΔV_{INT} shown in (b) of FIG. 16A is an amount by which the potential V_{INT} is boosted when the readout signal is applied from the line RWS to the sensor circuit during the readout period.

As described above, in the present embodiment, when the readout signal is applied from the line RWS, the potential of V_{INT} is caused to rise via the microswitch S1 in the ON state. After the readout period, the readout signal returns to the low level V_{RWS. L}, and charges flow from V_{INT} into the capacitor C_{INT}. Consequently, a floating state of charges that would cause the sensor output to be kept in an ON state can be avoided, and therefore, an output of the sensor circuit at each pixel can be obtained accurately.

As shown in (b) of FIG. 16A, in the sensor circuit according to the present embodiment, the potential of V_{INT} in the touched state (waveform F3) is greater than the potential of V_{INT} when light incident on the photodiode D1 is small in amount (waveform F1). Based on this, the touched state can be detected. It should be noted that a difference ΔV_{F3-F1} between the waveform F3 and the waveform F1 during the readout period, shown in (b) of FIG. 16A, coincides with an integral of a dark current in the photodiode D1.

### [7-2. Imager Mode]

In order to cause only the photodiode D1 to function, the following setting is provided as shown in (a) of FIG. 16B, which, however, is merely one embodiment: the low level V_{RST. L} and the high level V_{RST. H} of the reset signal are set to −7 V and 0 V, respectively, and the low level V_{RWS. L} and the high level V_{RWS. H} of the readout signal are set to −15 V and 0 V, respectively. With this setting of the read out signal, the thin-film transistor M4 can be kept non-conductive. In other words, since the potential owing to the readout signal does not rise to over the threshold value of the thin-film transistor M4, an operation of the microswitch S1 can be made ineffective.

When the readout signal is supplied, the injection of charges into the capacitor C_{INT} occurs. The potential V_{INT} of the gate of the thin-film transistor M2 in this state is expressed by the above-described formula (3). As is the case with the “hybrid mode” described above, the potential V_{INT} of the gate of the thin-film transistor M2 is made higher than the threshold voltage thereof by ΔV_{RWS}, which makes the thin-film transistor M2 conductive. Thus, the thin-film transistor M2, together with the thin-film transistor M3 provided at an end of the line OUT in each column, functions as a source follower amplifier.

In (b) of FIG. 16B, the waveform F1 indicated by a solid line represents variation of the potential V_{INT} when light incident on the photodiode D1 is small in amount. The waveform F2 indicated by a broken line represents variation of the potential V_{INT} when light at a saturation level is incident on the photodiode D1.

Like when the microswitch S1 is in the OFF state in the “hybrid mode” described above, the sensor output voltage V_{PIX} from the thin-film transistor M2 is proportional to an integral of the photoelectric current of the photodiode D1 during the integration period.

### [7-3. Touch Mode]

In order to cause only the microswitch S1 to function, a forward voltage of the photodiode D1 is prevented from being generated. The following setting is provided as shown in (a) of FIG. 16C, which, however, is merely one embodiment: the low level V_{RST. L} and the high level V_{RST. H} of the reset signal are set to −7 V and 0 V, respectively, and the low level V_{RWS. L} and the high level V_{RWS. H} of the readout signal are set to −7 V and 8 V, respectively. In the present embodiment, since a DC power source is not used for the reset signal, the readout signal is supplied immediately after the reset signal is supplied, so that a forward voltage of the photodiode D1 should not be generated. Thus, the timing at which a forward voltage of the photodiode D1 is not generated is utilized as the readout period, whereby the photodiode D1 is made ineffective.

When the microswitch S1 is in the OFF state (in the non-touched state), the potential V_{INT} of the gate of the thin-film transistor M2 becomes higher than the threshold voltage of the thin-film transistor M2, like when the microswitch S1 is in the OFF state in the above-described “hybrid mode”. This causes the thin-film transistor M2 to become conductive, and the thin-film transistor M2, together with the thin-film transistor M3 provided at an end of the line OUT in each column, functions as a source follower amplifier.

When the microswitch S1 is in the ON state (in the touched state), the potential V_{INT} of the gate of the thin-film transistor M2 is boosted up upon the supply of the readout signal, like when the microswitch S1 is in the ON state in the “hybrid mode” described above. More specifically, since the microswitch S1 is connected to the line RWS, the potential V_{INT} of the gate of the thin-film transistor M2 is boosted up via the microswitch S1 and the thin-film transistor M4. Therefore, the potential V_{INT} of the gate of the thin-film transistor M2 has a value obtained by subtracting the threshold voltage of the thin-film transistor M4 from the high level V_{RWS. H} of the readout signal.

In this case, the potential V_{INT} of the gate of the thin-film transistor M2 is higher than the threshold voltage of the thin-film transistor M2, and therefore the thin-film transistor M2 becomes conductive. Therefore, the thin-film transistor M2, together with the thin-film transistor M3 provided at an end of the line OUT in each column, functions as a source follower amplifier. In other words, the sensor output voltage V_{PIX} from the thin-film transistor M2 coincides with a value obtained by subtracting the threshold voltage of the thin-film transistor M4 from a supplied voltage of the readout signal.

As shown in (b) of FIG. 16C, in the sensor circuit according to the present embodiment, the potential of V_{INT} in a touched state (waveform F3) is greater than the potential of V_{INT} in a non-touched state (waveform F1). Based on this, a touched state is detected.

### 8. Eighth Embodiment

Hereinafter, Eighth Embodiment is explained. The members having the same functions as those of First Embodiment explained above are denoted by the same reference numerals as those in First Embodiment, and detailed explanations of the same are omitted. FIG. 17 is an equivalent circuit diagram of a sensor circuit according to the present embodiment.

As shown in FIG. 17, the microswitch S1 of the sensor circuit according to the present embodiment is a horizontal-type switch in terms of the contact mechanism, in which an electrode thereof not connected with the thin-film transistor M4 is connected to the line RWS via the input electrode 50. Besides, in the sensor circuit according to the present embodiment, the control electrode of the thin-film transistor is connected to the line RST.

The microswitch S1, upon a touching operation, electrically connects the thin-film transistor M4 and the line RWS with each other. In the present embodiment, the microswitch S1 and the control electrode of the thin-film transistor M4 are connected to the line RST, whereby the number of lines can be decreased as compared with the configuration of First Embodiment. This simplifies the sensor circuit, and increases an aperture ratio.

### [8-1. Hybrid Mode]

An exemplary case where the sensor circuit according to the present embodiment is caused to operate in the hybrid mode is shown in FIG. 18A. (a) of FIG. 18A is a waveform diagram of a reset signal and a readout signal supplied to the sensor circuit according to the present embodiment. (b) of FIG. 18A is a waveform diagram showing potential variation of V_{INT} in response to the above-described input signals.

The sensor circuit according to the present embodiment is capable of reading out an amplified variation of a potential of the accumulation node during the integration period T_{INT}, as shown in (b) of FIG. 18A. In the example shown in (a) of FIG. 18A, which is merely one embodiment, the reset signal has a low level V_{RST. L} of −7 V, and a high level V_{RST. H} of 0 V. The readout signal has a low level V_{RWS. L} of −7 V, and a high level V_{RWS. H} of 8 V. It should be noted that in the present embodiment, since the mode control signal is not used, there is no signal input from a line MODE to the sensor circuit.

Here, a case where the microswitch S1 is in an OFF state (in a non-touched state) is explained. First, when the reset signal V_{RST. H} is supplied to the line RST, a voltage is applied to the control electrode of the thin-film transistor M4. However, when the microswitch S1 is in the OFF state, the thin-film transistor M4 does not become conductive. Therefore, the potential V_{INT} of the gate of the thin-film transistor M2 becomes substantially equal to the high level (0 V) of the reset signal.

Here, since the photodiode D1 is forward-biased, the potential V_{INT} of the gate of the thin-film transistor M2 is expressed by a formula identical to the above-described formula (1). Since V_{INT} in this state is lower than the threshold voltage of the thin-film transistor M2, the thin-film transistor M2 is non-conductive during a period while the high-level reset signal V_{RST. H} is being supplied.

Next, the reset signal returns to the low level V_{RST. L} (at the timing of t=T_{RST} in (b) of FIG. 18A), and thereby an electric current integration period (a sensing period that is a period after the supply of the reset signal before the supply of the readout signal, i.e., a period denoted by T_{INT} shown in (b) of FIG. 18A) starts. In the integration period, an electric current proportional to an amount of light incident on the photodiode D1 flows out of the capacitor C_{INT}, whereby the capacitor C_{INT} is discharged.

Here, the potential V_{INT} of the gate of the thin-film transistor M2 at the end of the integration period is determined by the above-described formula (2). During the integration period also, V_{INT} is lower than the threshold voltage of the thin-film transistor M2, and the thin-film transistor M2 therefore remains non-conductive.

After the integration period ends, the readout signal rises at the timing t=T_{RWS} shown in (b) of FIG. 18A, and the readout period thereby starts. It should be noted that the readout period continues while the readout signal remains at the high level. More specifically, during the readout period, the readout signal rises, but since the microswitch S1 is in the OFF state, the thin-film transistor M4 is non-conductive. In other words, the thin-film transistor M4 does not assume influence on the potential variation of V_{INT}. The potential V_{INT} of the gate of the thin-film transistor M2 in this state is expressed by the above-described formula (3). Thus, the potential V_{INT} of the gate of the thin-film transistor M2 becomes higher than the threshold voltage thereof, and this causes the thin-film transistor M2 to become conductive. Therefore, the thin-film transistor M2, together with the thin-film transistor M3 provided at an end of the line OUT in each column, functions as a source-follower amplifier. The sensor output voltage V_{PIX} from the thin-film transistor M2 is proportional to an integral of the photoelectric current of the photodiode D1 during the integration period.

On the other hand, a case where the microswitch S1 is in an ON state (in a touched state) is explained below. First, when the reset signal V_{RST. H} is supplied to the line RST, a voltage is applied to the control electrode of the thin-film transistor M4. Here, in the case where the microswitch S1 is in the ON state, the thin-film transistor M4 becomes conductive, and the potential V_{INT} of the gate of the thin-film transistor M2 becomes substantially equal to the low level (−7 V) of the readout signal. More specifically, since the reset signal is supplied to the photodiode D1, too, the potential V_{INT} is determined by a resistance ratio between the photodiode D1 and the thin-film transistor M4. In (b) of FIG. 18A, R1 represents variation in the case where the resistance of the photodiode D1 is greater than the resistance of the thin-film transistor M4, and R2 represents variation in the case where the resistance of the photodiode D1 is smaller than the resistance of the thin-film transistor M4. It should be noted that since V_{INT} in any one of the above-described cases is lower than the threshold voltage of the thin-film transistor M2, the thin-film transistor M2 is non-conductive during a period while the high-level reset signal V_{RST. H} is being supplied.

Here, the microswitch S1 is connected to the line RWS, but the thin-film transistor M4 is non-conductive. Therefore, even when the readout signal is supplied, the potential V_{INT} of the gate of the thin-film transistor M2 is not influenced by the same. Therefore, the potential V_{INT} of the gate of the thin-film transistor M2 is boosted according to the high level V_{RWS. H} of the readout signal. This causes the potential V_{INT} of the gate of the thin-film transistor M2 to become higher than the threshold voltage of the thin-film transistor M2, whereby the thin-film transistor M2 becomes conductive. Therefore, the thin-film transistor M2, together with the thin-film transistor M3 provided at an end of the line OUT in each column, functions as a source-follower amplifier.

In (b) of FIG. 18A, the waveform F1 indicated by a solid line represents variation of the potential V_{INT} in the case where the microswitch S1 is in the OFF state (in the non-touched state) and light incident on the photodiode D1 is small in amount. The waveform F2 indicated by a broken line represents variation of the potential V_{INT} in the case where the microswitch S1 is in the OFF state (in the non-touched state) and saturation-level light is incident on the photodiode D1, and variation of the potential V_{INT} in the case where the microswitch S1 is in the ON state (in the touched state). ΔV_{INT} shown in (b) of FIG. 18A is an amount by which the potential V_{INT} is boosted by the application of the readout signal from the line RWS to the sensor circuit during the readout period.

As described above, in the present embodiment, upon the application of the reset signal from the line RST to the sensor circuit, the potential V_{INT} is caused to fall via the microswitch S1 in the ON state. Then, the potential of V_{INT} is boosted up by the readout signal, whereby the sensor output assumes an ON state. After the readout period, the readout signal returns to the low level V_{RWS. L}. Therefore, the output of the sensor circuit at each pixel can be obtained accurately, by avoiding influence of the microswitch S1 that would cause the sensor output to be kept in an ON state.

As shown in (b) of FIG. 18A, in the sensor circuit according to the present embodiment, the potential of V_{INT} in a touched state (waveform F2) is smaller than the potential of V_{INT} in the case where light incident on the photodiode 1 is small in amount (waveform F1). Based on this, a touched state is detected.

### [8-2. Imager Mode]

In order to cause only the photodiode D1 to function, the following setting is provided as shown in (a) of FIG. 18B, which, however, is merely one embodiment: the low level V_{RST. L} and the high level V_{RST. H} of the reset signal are set to −7 V and 0 V, respectively, and the low level V_{RWS. L} and the high level V_{RWS. H} of the readout signal are set to −15 V and 0 V, respectively. With this setting of the read out signal, the thin-film transistor M4 can be kept non-conductive. In other words, since the potential owing to the readout signal does not rise to over the threshold value of the thin-film transistor M4, an operation of the microswitch S1 can be made ineffective.

When the readout signal is supplied, the injection of charges into the capacitor C_{INT} occurs. The potential V_{INT} of the gate of the thin-film transistor M2 in this state is expressed by the above-described formula (3). As is the case with the “hybrid mode” described above, the potential V_{INT} of the gate of the thin-film transistor M2 is made higher than the threshold voltage of the thin-film transistor M2 by ΔV_{RWS}, which makes the thin-film transistor M2 conductive. Thus, the thin-film transistor M2, together with the thin-film transistor M3 provided at an end of the line OUT in each column, functions as a source follower amplifier.

In (b) of FIG. 18B, the waveform F1 indicated by a solid line represents variation of the potential V_{INT} when light incident on the photodiode D1 is small in amount. The waveform F2 indicated by a broken line represents variation of the potential V_{INT} when light at a saturation level is incident on the photodiode D1.

Like when the microswitch S1 is in the OFF state in the “hybrid mode” described above, the sensor output voltage V_{PIX} from the thin-film transistor M2 is proportional to an integral of the photoelectric current of the photodiode D1 during the integration period.

### [8-3. Touch Mode]

In order to cause only the microswitch S1 to function, a forward voltage of the photodiode D1 is prevented from being generated. The following setting is provided as shown in (a) of FIG. 18C, which, however, is merely one embodiment: the low level V_{RST. L} and the high level V_{RST. H} of the reset signal are set to −7 V and 0 V, respectively, and the low level V_{RWS. L} and the high level V_{RWS. H} of the readout signal are set to −7 V and 8 V, respectively. In the present embodiment, since an output of a DC power source is not used for the reset signal, the readout signal is supplied immediately after the reset signal is supplied, so that a forward voltage of the photodiode D1 should not be generated. Thus, the timing at which a forward voltage of the photodiode D1 is not generated is utilized as the readout period, whereby the photodiode D1 is made ineffective.

When the microswitch S1 is in the OFF state (in the non-touched state), the potential V_{INT} of the gate of the thin-film transistor M2 becomes higher than the threshold voltage thereof during the readout period, like when the microswitch S1 is in the OFF state in the above-described “hybrid mode”. This causes the thin-film transistor M2 to become conductive, and the thin-film transistor M2, together with the thin-film transistor M3 provided at an end of the line OUT in each column, functions as a source follower amplifier.

When the microswitch S1 is in the ON state (in the touched state), upon the supply of the reset signal, the thin-film transistor M4 becomes conductive, like when the microswitch S1 is in the ON state in the above-described “hybrid mode”. This allows the potential V_{INT} of the gate of the thin-film transistor M2 to fall to the low-level voltage of the line RWS. During the readout period, the potential of V_{INT} is boosted up by the high-level voltage of the line RWS, and therefore, the thin-film transistor M2 becomes conductive. This causes the thin-film transistor M2, together with the thin-film transistor M3 provided at an end of the line OUT in each column, to function as a source-follower amplifier.

As shown in (b) of FIG. 18C, in the sensor circuit according to the present embodiment, the potential of V_{INT} in the touched state (waveform F3) is smaller than the potential of V_{INT} in the non-touched state (waveform F1). Based on this, the touched state can be detected.

So far First to Eighth Embodiments have been explained. The present invention, however, is not limited to the above-described embodiments, but may be modified variously within the scope of the invention.

For example, in the foregoing descriptions of First to Eighth Embodiments, the exemplary configuration is shown in which the lines VDD and the lines OUT connected to the sensor circuits are utilized also as the source lines COL. This configuration has an advantage that a high pixel aperture ratio is provided. However, with a configuration in which the lines VDD and the lines OUT for the optical sensors are provided separately from the source lines COL, the same effect can be achieved as the effect of the above-described First to Eighth Embodiments can be achieved.

The present invention is industrially applicable as a display apparatus having sensor circuits in a pixel region of an active matrix substrate.

1. A sensor circuit comprising:
a photodetecting element that receives incident light;
an accumulation part that is connected to the photodetecting element via an accumulation node and accumulates charges according to an electric current having flown through the photodetecting element;
a reset signal line to which a reset signal for initializing a potential of the accumulation node is supplied;
a readout signal line to which a readout signal for outputting the potential of the accumulation node is supplied;
a sensor switching element that is connected to an output line, so as to make the accumulation node and the output line conductive with each other in response to input of the readout signal, and to output an output signal according to the potential of the accumulation node to the output line;
a switch that is capable of switching connection and disconnection between the accumulation node and an input electrode to which a voltage is supplied, and that provides connection when a pressure is applied by a touching operation; and
a control switching element that is connected to between the switch and the accumulation node, and has a control electrode to which a control signal for switching conduction and non-conduction between the switch and the accumulation node is input.

2. The sensor circuit according to claim 1, wherein the control electrode of the control switching element is connected to a control line that supplies the control signal.

3. The sensor circuit according to claim 2, wherein the input electrode is connected to a reference voltage line to which a voltage is supplied.

4. The sensor circuit according to claim 2, wherein the input electrode is connected to the reset signal line.

5. The sensor circuit according to claim 2, wherein the input electrode is connected to the readout signal line.

6. The sensor circuit according to claim 1, wherein the sensor circuit is configured to operate in operation modes, the operation modes including:
an operation mode in which the control switching element is caused to operate according to the control signal when the readout signal is input so that the switch and the accumulation node are conductive with each other; and
an operation mode in which the control switching element is caused to operate according to the control signal so that the switch and the accumulation node are always non-conductive with each other.

7. The sensor circuit according to claim 1, wherein the control electrode of the control switching element is connected to the readout signal line.

8. The sensor circuit according to claim 7, wherein the input electrode is also connected to the readout signal line.

9. The sensor circuit according to claim 7, wherein the sensor circuit operates is configured to operate in operation modes, the operation modes including:
an operation mode in which a readout signal for making the control switching element conductive when the readout signal is input is supplied to the readout signal line; and
an operation mode in which a readout signal for making the control switching element non-conductive when the readout signal is input is supplied to the readout signal line.

10. The sensor circuit according to claim 1,
wherein the control electrode of the control switching element is connected to the reset signal line, and
the input electrode is connected to the readout signal line.

11. The sensor circuit according to claim 10, wherein the sensor circuit is configured to operate in operation modes, the operation modes including:
an operation mode in which a voltage of the readout signal is set so that the control switching element is conductive when the reset signal is input; and
an operation mode in which a voltage of the readout signal is set so that the control switching element is non-conductive when the reset signal is input.

12. A display apparatus comprising:
an active matrix substrate having a pixel region;
a counter substrate, and
the sensor circuit according to claim 1 in the pixel region of the active matrix substrate.

13. The display apparatus according to claim 12, wherein the switch includes:
a first electrode that is provided on the active matrix substrate and is connected to the accumulation node; and
a second electrode that is provided on the counter substrate and is connected to the input electrode, and
the first electrode and the second electrode are configured to be brought into contact with each other when the counter substrate is pressed by a touching operation with respect to the pixel region.

14. The display device according to claim 12,
wherein the switch includes:
a first electrode that is provided on the active matrix substrate and is connected to the accumulation node; and
a second electrode that is provided on the active matrix substrate at a distance from the first electrode, and is connected to the input electrode, and
the first electrode and the second electrode are configured to be brought into contact with a conductor provided on the counter substrate and become conductive with each other when the counter substrate is pressed by a touching operation with respect to the pixel region.

15. A sensor circuit comprising:
a photodetecting element that receives incident light;
an accumulation part that accumulates a potential according to an output electric current of the photodetecting element, in an accumulation node;
a reset signal line to which a reset signal for initializing a potential of the accumulation node is supplied;
a readout signal line to which a readout signal for reading out the potential of the accumulation node is supplied;
an amplification part that reads out the potential of the accumulation node in response to the readout signal and outputs an output signal according to the potential;
a switch for switching connection and disconnection from one to the other in response to a pressure applied by a touching operation; and
a control switching element that controls conduction and non-conduction between the switch and the accumulation node,
wherein the sensor circuit operates in at least two operation modes among an imager mode, a touch mode, and a hybrid mode,
wherein in the imager mode, the control switching element is controlled so that the potential of the accumulation node depends on an electric current that has flown through the photodetecting element during a period from the initialization by the reset signal to the readout by the readout signal,
in the touch mode, the control switching element is controlled so that the potential of the accumulation node depends on a connection state of the switch upon the readout by the readout signal, and
in the hybrid mode, the control switching element is controlled so that the potential of the accumulation node depends on both of the electric current having flown through the photodetecting element and the connection state of the switch.

16. The sensor circuit according to claim 15, wherein, in the imager mode,
a voltage of the reset signal is set so that charges corresponding to an electric current having flown through the photodetecting element are accumulated in the accumulation part during a period from the initialization of the accumulation node by the reset signal to the readout by the readout signal, and the control switching element is controlled so that it is non-conductive at least upon the readout.

17. The sensor circuit according to claim 15, wherein, in the touch mode, the voltage of the reset signal is set so that the accumulation node is initialized upon the readout, and the control switching element is controlled so that it is conductive upon the readout.

18. The sensor circuit according to claim 15, wherein, in the hybrid mode, the control switching element is controlled so that it is conductive upon readout,
a voltage of the reset signal is set so that charges corresponding to an electric current having flown through the photodetecting element are accumulated in the accumulation part during a period from the initialization of the accumulation node by the reset signal to the readout by the readout signal, and
when the switch is conductive upon readout, a voltage is applied to the switch.
